(19) United States
(12) Patent Application Publication
(10) Pub. No.: US 2010/0241732 A1
(43) Pub. Date: Sep. 23, 2010

(54) User Interfaces for Electronic Devices

(75) Inventor: Rafael del Valle Lopez, Barcelona (ES)

Correspondence Address: HAYES, SOLOWAY P.C., 175 CANAL STREET, MANCHESTER, NH, 03101, US

(73) Assignee: Vida Software S.L., Barcelona (ES)

(21) Appl. No.: 12/303,131

(22) PCT Filed: Jun. 1, 2007
(86) PCT No.: PCT/GB2007/002039

§ 371 Date: May 27, 2010

(30) Foreign Application Priority Data
Jun. 2, 2006 (GB) 0610946.6

(51) Int. Cl. G06F 9/46; G06F 15/16; G06F 3/048

(52) U.S. Cl. 709/219; 719/314; 719/318; 715/764

(57) ABSTRACT

A multi-modal user-interface for an electronic device comprises two user-interface components (10, 11). Each user-interface component (10, 11) has its own individual event queue (12, 13), event checking loop (14, 15), and “action listener” (16, 17). Each user-interface component (10, 11), identifies and detects user-interaction events and posts those events to its own respective event queue. The interaction event queues (12, 13) are arranged such that when an interaction event happens at one or other queue 1(2, 13), any appropriate user interface actions that are possible at the respective queue are executed immediately, and at the same time the event is reported to the interaction queue at the other user-interface component via a communications channel (18). In this way, a distributed interaction event queue arrangement is maintained.

The present invention relates to the provision of user interfaces for electronic devices, such as mobile phones, personal digital assistants, etc., and in particular to a system and method for providing so-called “multi-modal” user interfaces for such devices.

Electronic devices, such as mobile telephones, will typically include a so-called “user interface”, to allow a user to control the device and, e.g., to input information and control commands to the device, and/or to receive information from the device.

For example, a mobile device such as a telephone will typically include a screen or display for providing information to a user and a key-pad for allowing a user to input commands, etc., to the device.

It is also known to provide electronic devices with a so-called “speech-enabled” user interface, whereby a user may, e.g., control the device using voice (spoken) commands, and the device may provide information to the user in an audible form, e.g., as spoken “text”.

A user interface that offers plural different input and output modes, such as a screen, keypad and speech, is commonly referred to, as is known in the art, as a “multi-modal” user interface, since it provides multiple modes of user interface operation.

As is known in the art, a multi-modal user interface will typically be provided by or comprise a number of different software and/or hardware elements, that each provide different functions or operations of the user interface, such as a keyboard or keypad, a screen, an audio rendering device, a graphics rendering device, a speech recognition engine, a text-to-speech rendering engine, a device for recognising a user's emotion, etc. Each software and hardware element making up or contributing to the (multi-modal) user interface can be thought of as a component of the interface and, as discussed above, the overall user interface can and typically will comprise a number of such user interface components.

The user interface itself will be controlled by and activated via a number of “user interface controls” that, for example, define the display to be displayed to a user, define the speech prompts to be provided to a user, define the user actions to be deleted or monitored as part of the user-interface operation, and define the actions to be taken in response to user actions, etc. Examples of such controls are text display, buttons, speech prompts, text input fields, pictures, etc.

The user interface will also have associated with it one or more so-called “action listeners”, which in effect respond to interaction events and trigger appropriate actions in response thereto. For example, in the case of an email application, the interaction event of a user clicking on the “send” button will trigger a number of action listeners, such as some to update the user interface controls (to show the user's button press) and others to effect the underlying application logic, such as to start the network transaction required for sending the email itself. An action listener can thus be thought of as a “hook” that is used by applications to bind their logic to the user interface. Each action listener is triggered by appropriate (selected) interaction events and, e.g., modifies the available user interface controls to modify the user interface operation, and/or triggers underlying application actions in response to a user's actions.

In operation of an electronic device, the various components of the user interface, such as the screen, keypad and speech recognition engine, will typically monitor and detect interaction events (such as a user's actions over or via the user interface, such as keystrokes, spoken commands, touch-screen operations, etc.), and in response thereto trigger (by means of appropriate action listeners) actions that, e.g. update the user interface and/or its behaviour (e.g. modify the user interface controls), and/or that update or modify an application that the user is using, etc.

In a typical such arrangement, the user interface components will detect interaction events and then post those events to the underlying application. The application will monitor for and detect the posting of interaction events, and activate, via action listeners, the appropriate response or action when an event is detected.

In order to facilitate such operation, the application can maintain a so-called interaction event queue, where interaction events are enqueued and then dispatched for the appropriate action to be activated. In such an arrangement, the user interface components place or post interaction events that they detect to the interaction event queue as they detect them. A so-called event loop detects and processes the events in the queue and passes them to the appropriate action listeners to process the events and take the appropriate user interface actions (e.g. update status of user interface components and/or trigger the appropriate application logic, etc.) in response to the events.

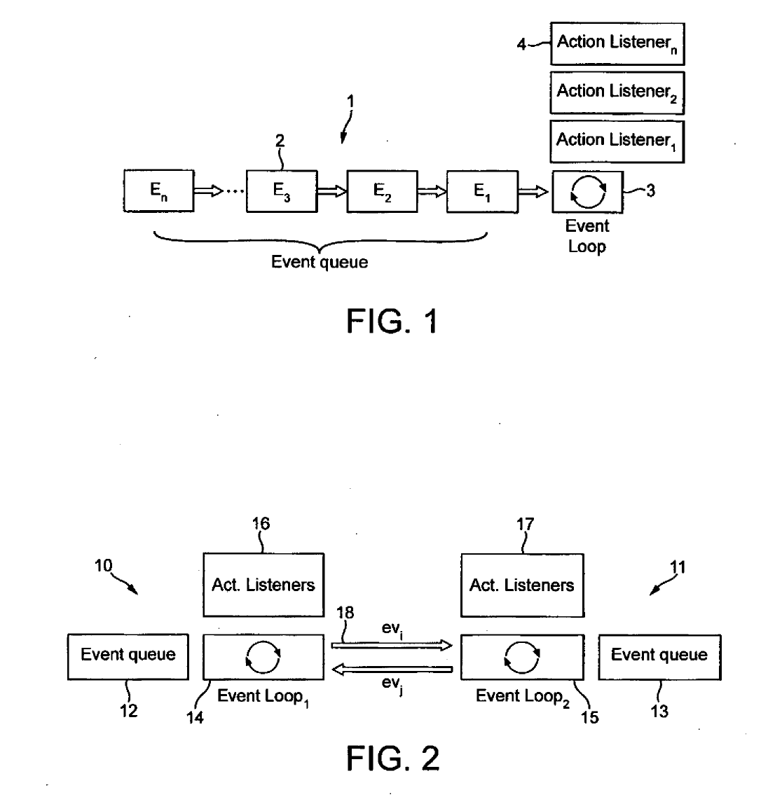

FIG. 1 illustrates this. As shown in FIG. 1, there is an interaction event queue 1 to which events 2 detected by user interface components are posted, and an event loop 3 which processes the events in the queue and which in particular passes the events to appropriate “action listeners” 4 which will respond to the interaction events in an appropriate manner, e.g. by updating or changing the user interface and/or its behaviour.

The Applicants believe that there remains scope for improvement to the provision of user interfaces for electronic devices, and in particular to the provision of multi-modal user interfaces for electronic devices.

According to a first aspect of the present invention, there is provided a method of providing a user-interface for an electronic device, in which the user-interface is comprised of two or more user-interface components, the method comprising:

providing two or more interaction event queues for the user-interface components.

According to a second aspect of the present invention, there is provided a system for providing a user-interface for an electronic device, in which the user-interface is, comprised of two or more user interface components, the system comprising:

means for providing two or more interaction event queues for the user interface components.

In the present invention, rather than having a single interaction event queue that is common to all the user-interface components and to which all the user interface components post their interaction events, two or more interaction queues are provided for the user interface components. This facilitates in particular a more distributed arrangement of user interface components.

The Applicants have recognised that in many user interface systems, such as, in particular, in multi-modal user interfaces for constrained devices, such as mobile phones, it may be desirable to arrange user interface components in a distributed fashion. For example, a mobile phone may have a speech recognition front-end that captures a user's spoken utterances, but it may be preferable for the actual speech recognition engine that processes the utterances to be arranged on a server of the communications network. The Applicants have further recognised that providing plural interaction event queues has advantages in such contexts, as it facilitates, e.g., arranging interaction queues more locally to the distributed user-interface components, thereby facilitating, e.g., reduced communication latencies and more immediate responses to events by the user-interface components.

The user-interface components can be any suitable such components, such as a screen, keypad, speech recognition engine, graphics rendering engine, audio rendering engine, text-to-speech rendering engine, as discussed above, or any other form of component that provides or participates in user-interface functions or operations, etc.

The plural interaction event queues can be arranged as desired. Preferably a separate interaction event queue is provided for each of two or more of the user interface components. Each user-interface component is preferably associated with one of the interaction event queues.

It would be possible for some of the user-interface components to share an interaction event queue (e.g. where there are three or more user-interface components), i.e. such that an event queue or queues has plural user-interface components associated with it. However, in a particularly preferred embodiment, each user-interface component has its own, separate, individual, interaction event queue, i.e. such that each interaction event queue is associated with a single user-interface component only. Thus, there are preferably plural user-interface components, and the same number of separate interaction event queues, one for each user-interface component.

The interaction event queues may be provided as desired. In a preferred embodiment, each interaction event queue is provided in or on the user-interface component to which it relates. Preferably the interaction event queue is part of the user interface component, or is closely coupled to it (or closely coupled to a group of user-interface components, where a group of user-interface components share the same interaction event queue). Thus, in a preferred embodiment, two or more user-interface components comprise, and preferably each user-interface component comprises, an interaction event queue. In a particularly preferred embodiment, there are plural user interface components and preferably each user interface component maintains an interaction queue. Each user-interface component is preferably associated with one of the interaction event queues.

The user interface components can post the interaction events that they detect to the interaction queues as desired. Each user interface component preferably at least posts events to its own interaction event queue (the interaction event queue it is associated with). In a preferred embodiment, each user interface component is arranged to preferentially, and preferably to only, send, initially at least, its interaction events to selected, e.g. predetermined, interaction queues and most preferably to a particular, selected, one of the interaction queues only. In a preferred arrangement, where the user-interface components each have their own, individual interaction queues, each user-interface component only sends its events to its corresponding own interaction queue.

In a preferred embodiment, the arrangement is such that some actions in response to user events can be and preferably are taken locally to the user-interface component in question. These actions preferably comprise those actions that are naturally local to the user-interface component, such as updating the user-interface component's own state, etc.

In a particularly preferred embodiment, the plural interaction queues are kept updated with events that are posted on other ones of the interaction queues. Thus, an event posted at a given interaction event queue can preferably be, and preferably is also, posted (e.g. simultaneously or thereafter) to some or all of the other interaction event queues. Thus, in a preferred embodiment, an and preferably each event queue can post some or all of its events to another event queue or queues. For example, two event queues could share some of the events that are posted to them (such as those events that are known to be useful to a or the user interface component that is associated with the other event queue).

Thus, in a preferred embodiment some or all of the events posted to a given event queue can be selectively posted to some or all of the other interaction event queues (e.g. depending on the nature of the event).

Thus, in a preferred embodiment, one or more and preferably each interaction event queue can selectively transmit events posted to it to another and/or to plural other and/or to the other (or selected ones of the other) interaction event queues. Similarly, in a preferred embodiment, one or more and preferably each user interface component comprises means for selectively transmitting interaction events to another user interface component and/or to the event queue of another user interface component.

In these arrangements, an event queue preferably treats “foreign” events that it receives events from other event queues or user interface components) as if those events were locally generated.

Events are preferably time-stamped, to allow event queues and action listeners to determine if they are still valid or not when they come to be processed. For example, a user may start a speech interaction but then while the interaction is happening take an action, such as closing the application, which invalidates the previous action. Similarly, events can preferably be allocated priorities, that event queues can then take into consideration (for example to advance the progress of higher priority events).

In a particularly preferred embodiment, when an interaction event is registered at a given queue, then the appropriate (and possible) user interface action(s) is performed in response to the event at the queue's “location” (e.g. and preferably in the user-interface component or components associated with the event queue), where it is possible and appropriate to do that, without the system waiting for other event queues to be updated with the new event. In other words, any actions possible at the user-interface component or components local to and/or associated with an interaction event queue to which an event is posted can preferably be and are preferably performed without waiting (needing to wait) for the event to be posted to other event queues.

Thus, for example, actions possible at the user-interface component or components associated with the event queue to which an event is first posted are preferably initiated and/or performed immediately, without waiting for the event to be posted to any other event queues.

Thus, in a preferred embodiment, the system does not delay the processing of an event at any event queue until the event has been posted to all appropriate event queues. Similarly, when an event queue receives an event from another queue, it again preferably can start to and preferably does start to process and action that event as soon as it can. In this way, user-interface actions are not delayed by waiting for the respective interaction queues to be kept up-to-date.

The use of plural interaction queues in this manner provides, in effect, a distributed interaction queue arrangement. This facilitates, for example, optimising the latency time between an event occurring and the corresponding user interface action in response thereto (since the latency time can be made to correspond to the latency time of the channel that connects the event queues). It can also facilitate distribution of user-interface components across devices, networks, servers, etc., and sharing user-interface components among multiple applications running concurrently or simultaneously.

It is believed that such an arrangement may be new and advantageous in its own right. Thus, according to a third aspect of the present invention, there is provided a method of providing a user-interface for an electronic device, which user-interface is provided via a plurality of user-interface components, the method comprising:

maintaining a separate user-interface interaction event queue for each of two or more of the user-interface components.

According to a fourth aspect of the present invention, there is provided a system for providing a user-interface for an electronic device, the system comprising:

a plurality of user-interface components; and

means for maintaining a user-interface interaction event queue for each of two or more of the user-interface components.

As will be appreciated by those skilled in the art, these aspects of the invention can and preferably do include any one or more and preferably all of the preferred and optional features of the invention described herein, as appropriate. Thus, for example, the plural interaction queues are preferably kept updated with events added to the other queue or queues, and thus there is preferably a step of or means for selectively signalling interaction events between the interaction event queues. Similarly, any given user interface component can and preferably will act upon an event posted to its queue without waiting for the event to be posted to the other queues.

The posting of events and other messages between the various interaction queues in the present invention can be carried, out in any appropriate manner. Thus, for example, there could be direct or one-to-one communication (and communication channels) arranged between the interaction queues for the posting of events from one queue to another, etc.

However, in a particularly preferred embodiment, interaction event queues, and/or user-interface components, are linked to each other via a publish-subscribe bus that is used for communicating signalling messages, etc., such as interaction events, among the queues and user-interface components, i.e. an arrangement in which messages (signalling) are sent on the bus (published) with an associated subject indicator (e.g., tag), which subject indicator is then used by other components and queues linked by the bus to decide whether to pick up (subscribe to) the message or not. In other words, signalling messages such as interaction events are “published” (transmitted) on the bus with subject identifiers according to their content, to allow recipients to selectively accept (subscribe to) the messages, as is known in the art.

Thus, in a preferred embodiment, two or more of, and preferably all of, the event queues are linked to each other via a publish-subscribe bus arrangement. There could, e.g., be a single publish-subscribe bus to which all the event queues are coupled (which all the event queues can communicate via), or there could be plural such buses, with each bus linking a selected and/or different group of event queues to each other.

Using a publish-subscribe bus arrangement facilitates, inter alia, sending event updates, etc., to many recipients simultaneously, without, e.g., needing to independently address the same message to each individual recipient. Such an arrangement has significant advantages in the context of a distributed interaction queue arrangement as in the present invention. For example, it is likely in use of the present invention that a given interaction event may need to be distributed to multiple user-interface components simultaneously. Using a publish-subscribe bus arrangement for signalling facilitates this. Thus, in a particularly preferred embodiment, the interaction event queues and/or user-interface components, are linked via a publish-subscribe bus arrangement, as this will allow them more readily to post interaction events to all components that could be interested in those events.

It is again believed that such an arrangement may be new and advantageous in its own right. Thus, according to a fifth aspect of the present invention, there is provided a system for providing a user-interface for an electronic device, the system comprising:

plural user-interface components and/or plural user interface interaction event queues; and

a publish-subscribe bus arrangement linking the user interface components and/or user-interface interaction event queues.

According to a sixth aspect of the present invention, there is provided a method of operating a user-interface for an electronic device; in which the user-interface comprises plural user-interface components and/or plural user interface interaction event queues, the method comprising:

transmitting messages between the user-interface components and/or user-interface interaction event queues using a publish-subscribe bus arrangement.

As will be appreciated by those skilled in the art, these aspects and embodiments of the invention again can and preferably do include any one or more or all of the preferred and optional features of the invention described herein, as appropriate.

As discussed above, the Applicants have recognised that it may be desirable in some multi-modal user interface arrangements to distribute the user-interface components as between the client or terminal side of the system and the network or server side of the system. For example, the user's electronic device, such as a mobile telephone, may have screen, keypad and graphics rendering components, but speech processing functions, such as an automatic speech recognition engine, may be carried out and located on, e.g. a platform or server of or accessible via the communications system network (infrastructure).

Indeed, it is a preferred embodiment of the present invention for there to be one or more user-interface components on the electronic device (client side), and for there to be one or more user-interface components on or accessible via a communications network to which the electronic device can connect (i.e. on the server side).

In such arrangements, one or more interaction event queues are preferably maintained on both the client side and server side of the system, e.g., and preferably, such that there are one or more user-interface components having associated event queues on the electronic device, and there are one or more user-interface components having associated event queues on or accessible via the communications network.

In these arrangements, interaction events are preferably communicated between the interaction queues and from the client side to the server side and vice-versa, as appropriate. For example, there may be a set of interaction event queues and user-interface components in the client terminal device which are in communication with each other, and another set of interaction event queues and user-interface components on the server (infrastructure) side which are in communication with each other, with there also being a communications link between the interaction event queues of the client side and the server side.

Indeed, it is an important advantage of the present invention that it facilitates such arrangements.

It is believed that such an arrangement may be new and advantageous in its own right. Thus, according to a seventh aspect of the present invention, there is provided a method of operating a user-interface for an electronic device that is in communication with a communications network, the method comprising:

maintaining a user-interface interaction event queue on both the electronic device and on the communications network.

According to an eighth aspect of the present invention, there is provided a communications system comprising:

means for maintaining a user-interface interaction event queue on the network infrastructure of the communications system; and

one or more communications devices, the or each communications device comprising means for maintaining a user-interface interaction event queue.

As will be appreciated by those skilled in the art, these aspects and embodiments of the invention again can and preferably do include any one or more or all of the preferred and optional features of the invention described herein. Thus, for example, there are preferably plural, preferably linked, interaction event queues on the client side and on the server (infrastructure) side, and interaction events are preferably (selectively) communicated between the device (client) and network (server) sides. Similarly, the electronic device preferably has one or more user-interface components, each having an associated event queue, and the communications network preferably has one or more user-interface components, each having an associated event queue.

In such an arrangement, the interaction event communication between the client side (e.g. communications device or terminal) and the server side (e.g. a server or platform of the communications network) can be carried out in any desired and suitable manner. For example, where the communications system supports publish-subscribe communications between the client and server sides, then there could, in effect be a single publish-subscribe bus which spans the client and server sides and to which all the event queues and user-interface components on the client side and on the server side are coupled and via which they communicate with each other.

On the other hand, where, e.g., the communications network does not support direct publish-subscribe communication between the client and server sides, and/or there is an existing signalling infrastructure, then the communication of events between the client and server sides may be, and preferably is, carried out by tunnelling the appropriate communications over (e.g. existing) communication channels of the communications system (e.g. by encapsulating the message(s) into the communications network's signalling protocol and passing it (tunnelling it) across the network to the other side (device) for receipt by the appropriate components). In such an arrangement, the signalling tunnel may, e.g., simply tunnel all events to the other side, or it may, e.g., have some form of control or processing to identify and only tunnel events that are known to be of interest at the other side.

In a preferred such arrangement, both the client side (electronic device) user-interface components and/or interaction event queues, and the user-interface components and/or event queues on the network (server) side (which may, e.g., be on a platform or server of or accessible via the communications network), are respectively linked to each other via a publish-subscribe bus, in the manner discussed above, with these separate publish-subscribe buses being linked, e.g., via the tunnelling of messages, as discussed above. Thus, both the electronic device(s) and the network-side platform or server preferably include publish-subscribe buses linking their respective user-interface components and/or interaction event queues.

In such an embodiment, where the publish-subscribe buses of the network side and electronic device(s) can preferably be and preferably are linked or coupled (in use), e.g. via a signalling tunnel, they can be considered, in effect, to form a single (virtual) logical publish-subscribe bus for communications between the user-interface components and/or interaction event queues of the electronic device(s) and of the communications network infrastructure.

Thus, in a particularly preferred embodiment, there is a publish-subscribe bus arrangement linking user-interface components and/or interaction event queues on communications network infrastructure (server side), and a publish-subscribe bus arrangement linking user-interface components and/or interaction event queues on the communications device (the client side), which buses are linked so as to provide a publish-subscribe signalling arrangement between the network infrastructure and the communication device. As discussed above, this could be achieved by having a single overall publish-subscribe bus linking all the queues and components where the communication network supports that, or, e.g., by having separate publish-subscribe buses on the client side and on the server (network) side which are then linked, e.g., by a signalling “tunnel” that uses, e.g., a standard or existing communications channel of the communications system (and that can handle “publish-subscribe” signalling traffic).

It is believed that the use of a publish-subscribe bus for signalling between electronic devices and a communications network infrastructure may be new and advantageous in its own right. Thus, according to a ninth aspect of the present invention, there is provided a method of transmitting signalling messages between an electronic device and one or more components on or accessible via a communications network for performing one or more user-interface functions or tasks for providing a user-interface to the electronic device, the method comprising:

communicating messages between the electronic device and the component or components for performing one or more user-interface functions using a publish-subscribe bus arrangement.

According to a tenth aspect of the present invention, there is provided a system, comprising:

one or more electronic devices;

a communications network;

one or more components on or accessible via the communications network for performing one or more user-interface functions or tasks for providing user-interface functions for the electronic devices;

and a publish-subscribe bus arrangement for communicating messages between the component or components for performing user-interface functions or tasks and a electronic device.

As will be appreciated by those skilled in the art, these aspects of the present invention can and preferably do include one or more and preferably all of the preferred and optional features of the invention described herein. Thus, for example, the messages preferably relate to user-interface functions or tasks, and most preferably comprise interaction events. Similarly, the publish-subscribe bus arrangement, preferably comprises a publish-subscribe bus linking the “user-interface” components of or accessible via the network infrastructure, and a publish-subscribe bus on the or each electronic device, which buses are linked (e.g. and preferably by tunnelling messages over existing communications channels of the communications network) so as to provide a (logical) publish-subscribe messaging arrangement between the infrastructure user interface components and the electronic device(s) (their user-interface components) for, preferably, communicating interaction events.

In other words, in a preferred embodiment two independent publish-subscribe buses (bus arrangements) (one on the client side and one on the server side) are preferably joined, preferably via a signalling tunnel, to form a single (virtual) publish-subscribe bus.

In these arrangements, the signalling tunnel (or other communication arrangement linking the client and server sides) can, as discussed above, preferably selectively transmit and/or filter messages (e.g. interaction events) that are passed from one side to the other, for example based on their subject. This helps to avoid unnecessary tunnelling of messages. Thus, the system preferably further comprises means for or a step of deciding whether or not to pass a message (e.g. pass it through the tunnel) to the other side (bus).

As will be appreciated by those skilled in the art, it would be possible in these arrangements to have plural electronic devices and/or plural user-interface components on the network side, all arranged and linked in this manner. In this case, there may be, for example, plural network channels, or signalling (tunnelling) channels, provided, if desired.

It will also be appreciated by those skilled in the art that in these aspects and embodiments of the invention, as well as the various user-interface signalling messages (e.g. interaction events), etc., referred to above, they may also be transmission of media, such audio and/or visual content, between components and between the client and server sides. The communication of such media content, etc., can take place as desired, for example via and using existing media communications channels and protocols.

The various user interface events and actions that are detected and performed in multi-modal user interface enabled applications are, as is known in the art, and as discussed above, typically configured as a series of user-interface controls for triggering the various user interface functions and operations. Thus there may be, for example, controls to display particular visual prompts or to provide particular spoken prompts, to detect particular keyboard or spoken inputs, to perform particular functions in response thereto, to detect interaction events, to detect or access a user's “emotion”, to provide particular visual prompts, etc.

The “user-interface controls” for an application are typically prepared as a set or series of data and instructions relating to and for effecting the user interface controls, such as XML or voice XML tags (as appropriate) in XML authoring content pages, that set out the various interaction elements and events, as is known in the art. Other arrangements are of course possible. A typical multi-modal enabled application will comprise a series of user-interface controls, which controls are activated or executed as required during execution of the application. The sequence of user-interface controls will typically follow one another in a single control flow loop, in which user actions are identified and then processed and turned into user-interface changes based on the current application status and/or logic.

In the case of Internet browsing, the user-interface controls data and/or instructions are usually provided within the web pages that are to be browsed (e.g. as XML tags). Thus, for example, an Internet content page (e.g. XML page) may contain user-interface control tags, to, e.g., display visual prompts, trigger an audio prompt, link to another web page in response to a keyboard or display input, link to another web page in response to a spoken input (e.g. a command to look for a particular spoken command (grammar) and in response to detection of that command to then go to a link), etc.

In such an arrangement, a browser of the electronic device will request the desired web content and then, when it receives the retrieved web content (e.g. web page), it will identify any user-interface control data and/or instructions embedded in the web page, extract the user-interface control data and instructions, and pass them to the appropriate user-interface components for execution.

(As is known in the art, when Internet browsing, browsing content is stored as content pages which, e.g., specify and are rendered as a set of user-interface controls for displaying the desired Internet content. The content pages are stored on a content server or servers, which are computer servers from which content pages can be requested and received, e.g., via a network connection. The requests for the content'pages are generated via a browser, which is an application that can use content pages requested and received from a content server to interact with a user.)

Such an arrangement could be used in the present invention. However, in a particularly preferred embodiment of the present invention, rather than a browser of the electronic device requesting and receiving Internet content from a content server of or accessible via a communications network directly, a content proxy is provided on or via the communications network infrastructure that can receive content requests from an electronic device's browser, and then forward that request to a content server of or accessible via the network. (As is known in the art, a content proxy is a network element that can receive requests for content pages from a browser and forward those requests to a content server on behalf of the requesting browser.)

In other words, in a particularly preferred embodiment of the present invention, when an electronic device (a browser application running on the device) makes a request for web content from a content server, that web content request is passed to a content proxy component (of or accessible via the communications system infrastructure) which will then fetch the requested content from the content server (e.g. of or accessible via the communications network).

In these embodiments, the Internet browser content proxy can be provided and configured in any appropriate manner on or via the communications network. It is preferably provided on or as part of a platform or server that is on or accessible via the communications network. It will, in effect, comprise a user-interface component that is located on the server side of the system (e.g. on a platform or server on the communication network infrastructure).

Thus, in a particularly preferred embodiment, the system of the present invention includes a user-interface component on or accessible via a communications network (to which the electronic device can connect) that can act as a content proxy for browsing applications of electronic devices of or using the network.

In these arrangements, the content proxy on or accessible via the communications network is preferably arranged in a similar manner to that discussed above for user-interface components of the system. Thus, it preferably has its own interaction event queue, preferably arranged in the manner as discussed above (i.e. as part of a distributed set of interaction event queues). Preferably the content browser(s) on the electronic device(s) has an interaction event queue arrangement as well (since it will similarly function as a user-interface component of the electronic device), and most preferably interaction events can, e.g., be published and subscribed both by and from the browser and the content proxy on or accessible via the communications network.

In a particularly preferred embodiment, the content proxy on or accessible via the network can and preferably does (or comprises means to) identify (data and/or instructions relating to) user interface controls, such as voice tags, speech recognition grammars, etc., in the (web) content (page(s)) it fetches (that are served from the content servers), and preferably can, preferably selectively, process or cause to be processed any (data and/or instructions relating to) user interface controls in the content that are applicable to the server side. In other words user interface controls specified in or by the content are preferably effected (processed) as they pass through the content proxy.

Most preferably the content proxy can identify and process or cause to be processed, data and/or instructions relating to or for user interface controls in the fetched content that are relevant to or required by user-interface components that are arranged on the network (server) side of the system. This could be done, e.g., by the content proxy identifying interaction events and then triggering appropriate actions in response thereto. In a preferred arrangement, the content proxy can and does accordingly identify and process (data and/or instructions relating to or for) user-interface controls in the fetched content relating to speech-based, and/or non-visual, user-interface modes, such as voice tags, speech recognition grammars, etc.

Thus, in a particularly preferred embodiment of the present invention, the content proxy is able to identify, and, most preferably, to process in some way, data and/or instructions relating to or for user interface controls (such as user interface related commands or data, etc.) that are included in the content or resources that it fetches from a content server for provision to an electronic device. Thus, the content proxy preferably includes means for or can perform steps of retrieving content including data and/or instructions relating to or for user interface controls from content server(s) on or accessible via the communications network and then acting upon, and/or providing to an electronic device the data and/or instructions relating to or for user interface controls, the user interface controls, content etc., as appropriate.

In these arrangements, the content proxy can process the data and/or instructions relating to or for user interface controls it identifies in any appropriate and desired manner. In a particularly preferred embodiment, the content proxy can execute user interface controls that are specified in the content it retrieves, most preferably by publishing interaction events in response to those user-interface controls (which interaction events can then be detected by and responded to by other user-interface components, e.g. on the server side). For example, in the case of a speech recognition grammar user-interface control, the content proxy could, upon recognition of (the specification of) such a user-interface control, post an interaction event to activate the necessary resources for recognising the speech, or, in the case of providing a spoken prompt, post events to trigger the fetching or generating of the relevant spoken prompt for provision to the electronic device by the appropriate user-interface components. Thus, the content proxy preferably processes the (data and/or instructions relating to or for) user interface controls by generating (or publishing) the relevant (corresponding or associated) interaction events.

In other words, the content proxy can preferably execute user-interface controls specified in content (pages) that pass through (and as they pass through) the content proxy, and most preferably does so by publishing interaction events in response to user-interface controls specified in the content (which events are passed to other user-interface components, which then execute actions and trigger new events in response thereto, and so on). Thus, content proxy preferably can and preferably does trigger interaction events in response to user-interface controls specified in the content.

The effect of this is that the content proxy can and will execute part of the user-interface function and operation, and will, in effect, coordinate and orchestrate user-interface functions on the server (network) side of the system (by publishing interaction events to trigger operations of user-interface components on the server side, fetch resources on the server, side, etc.).

In a preferred embodiment the content proxy can also or instead remove or filter some or all of the data and/or instructions relating to or for user interface controls from the fetched content and/or resources before it is provided to the electronic device. This would allow the content proxy to, in effect, separate the user interface controls that it will process from the content and/or resources required by the electronic device before the content and/or resources is provided to the device.

The provision of a content proxy that can identify user interface controls and process them in this way before the content is provided to an electronic device, facilitates, for example, more efficient processing of the user interface controls, and also, e.g., can reduce the processing burden on the electronic device itself (since the device will no longer need to identify and process (or pass for processing) the relevant user interface controls).

It also facilitates, e.g., activating user-interface components on the server (e.g. network) side (e.g. communications network infrastructure) without the data and/or instructions relating to the user interface controls, e.g., needing first to be passed to the electronic device. This facilitates, for example, more efficient operation, as it can reduce delays and latencies in the system. Similarly, it can facilitate the electronic device being provided simply with the web content it expects, whilst the user-interface components on the network side can independently process the user interface controls specified in the web content without the electronic device needing to do anything in that regard. This, inter alia, can reduce the processing burden on the electronic device, and reduce delays in the processing of the user interface controls specified in the web content.

It is believed that these methods and arrangements may be new and advantageous in their own right. Thus, according to an eleventh aspect of the present invention, there is provided a method of operating a system comprising one or more electronic devices, a content server or servers for providing content for applications of the electronic devices, and one or more components for providing user-interface functions for the electronic devices, the method comprising:

an electronic device transmitting a request for content from a content server;

a component for providing user-interface functions receiving the request and in response thereto fetching the requested content from a content server;

the component for providing user-interface functions identifying and processing data and/or instructions relating to one or more user interface controls included in the fetched content and providing the content to the electronic device.

According to a twelfth aspect of the present invention, there is provided a system comprising one or more electronic devices, one or more content servers for providing content for applications of the electronic devices, and one or more components for providing user-interface functions for the electronic device, wherein:

a or each electronic device comprises means for transmitting a request for content from a content server;

a or more than one component for providing user-interface functions for the electronic devices comprises means for receiving the request and in response thereto fetching the requested content from the content server, and means for identifying and processing data and/or instructions relating to or for one or more user interface controls included in the fetched content and for providing the content to the electronic device.

According to a thirteenth aspect of the present invention, there is provided a component for providing user interface functions for electronic devices, comprising:

means for receiving a request for content from an electronic device;

means for, in response to a received request, fetching the requested content from a content server of or accessible via a communications system; and

means for identifying and processing data and/or instructions relating to or for one or more user interface controls included in the fetched content and for providing the content to the electronic device.

As will be appreciated by those skilled in the art, these aspects of the invention can and preferably do include any one or more or all of the preferred and optional features of the invention described herein.

Thus, for example, the component or components for providing the user-interface functions are preferably provided on or are accessible via a communications network to which the electronic devices can connect (and are thus arranged on a network (server) side of the system). The component or components similarly also preferably execute the corresponding user interface controls, and preferably generate (publish) interaction events in response to the user-interface controls, for example to trigger speech recognition grammars or the provision of speech prompts to the electronic device. It or they can preferably also identify and remove data and/or instructions relating to user interface controls in the content fetched from a content server, and provide the so-modified content to an electronic device. These user-interface components similarly preferably have an interaction event queue or queues, etc., associated with them, as discussed above.

In these aspects and arrangements of the invention, the component for processing and identifying, etc., the user interface controls, etc., preferably comprises a content proxy, preferably as discussed above. In other words, the system preferably comprises a content proxy, as discussed above, which performs the user interface control processing and identification, etc., as discussed above.

The content servers in these and the other aspects and arrangements of the invention may be arranged as desired. Thus they could, e.g., comprise or be part of a host platform on a communications network, or be servers that are accessible via a communications network.

When operating to fetch content, etc., the content proxy is preferably configured to act such that it will allow the relevant content to pass through it and is independent of the source and receiver of the content. This facilitates the applications on the electronic devices, their content and resources, etc., being implementable independently of the content proxy and other user-interface components.

The above discusses in particular browsing applications, where the user-interface controls are defined in the content pages to be browsed (in the form of, for instance, XML tags).

In the case of other applications, such as terminal applications (i.e. applications in which some or most of the application software and hardware is in the terminal device), such as games, for example, in known systems all the user-interface controls are usually defined (specified) within the (program code for the) application itself. However, the Applicants have recognised that this can be disadvantageous in the case of multi-modal applications, particularly where the user-interface components are to be distributed, because it may then, for example, require the terminal device to process and/or post data and/or instructions relating to user interface controls to other, distributed parts of the system, thereby leading to processing latencies, etc.

Thus, in a particularly preferred embodiment of the present invention, where an application has user-interface controls to be associated with it, some of the user-interface controls for an application are not specified in the application code or with the application itself, but are specified in a separate document or file that can be activated and executed concurrently with the application. In other words, a separate “user interface controls” file or files is preferably provided, which is or is to be, executed simultaneously with an application (or applications).

These files could, e.g., store all of the data and/or instructions for all of the user interface controls for an application. However, in a preferred embodiment, the separate user-interface controls file or files specifies some of the user-interface controls for the application, with other user-interface controls, e.g., still being defined within or with the application code itself.

For example, it may be preferable for visual and keyboard related user-interface controls to remain at or with the application code (so that they are local to the electronic device), whereas other user-interface controls, such as speech prompts, speech processing controls, etc., may be more suitably specified (and stored) as separate files.

These arrangements provide a way of de-coupling some of the user-interface controls from the application code itself. In effect, some of the user-interface controls are de-coupled from the application code and, e.g., specified instead in content files to be accessed by (e.g. distributed) user-interface components as required. This facilitates, for example, storing and providing user interface controls for an application independently of the application itself (such that they can, e.g., be provided in a distributed fashion, if desired). This would allow, e.g., some user-interface controls, e.g. that are to be accessed and used by other, distributed user-interface components, to be stored more locally to those user-interface components, rather than at the terminal device with the application code, thereby further facilitating a distributed, multi-modal user interface arrangement with enhanced (reduced) latency times.

Storing (data and/or instructions relating to) user interface controls as separate files in this manner could also be used to allow, e.g., the user interface controls to be shared between several applications. It also facilitates, e.g., storing the user-interface controls separately to the electronic device itself, thereby, e.g., not using resources (such as memory) of the electronic device for this purpose, and also, e.g., removing constraints that may be imposed due to the limited resources (e.g. memory) that may be available on the device itself (for example, it can be the case that some speech recognition grammars, for example, can require memory in excess of the storage capability of some devices).

It is believed that such arrangements may be new and advantageous in their own right. Thus, according to a fourteenth aspect of the present invention, there is provided a system for providing user-interface functions for an application that is to be executed on an electronic device, the system comprising:

means for storing separately to the program code for the application, a set of data and/or instructions relating to or for user-interface controls to be executed during execution of the application and for providing user-interface functions and operations of the application.

According to a fifteenth aspect of the present invention, there is provided a method of providing user-interface functions for an application that is to be executed on an electronic device, the method comprising:

storing separately to the program code for the application, a set of data and/or instructions relating to or for user-interface controls to be executed during execution of the application and for providing user-interface functions and operations of the application.

As will be appreciated by those skilled in the art, these aspects and embodiments of the invention can and preferably do include any one or more or all of the preferred and optional features of the invention described herein, as appropriate.

In these arrangements, the user interface controls that are specified in a separate file can be selected as desired. They preferably comprise user-interface controls that may be executed on or using distributed user-interface components of a user-interface system, such as speech prompts, recognition grammars, etc. There may be one set of data and/or instructions relating to or for the user-interface controls, or plural sets, as desired.

The data and/or instructions relating to or for the user interface controls can also be stored where and as desired. In a particularly preferred embodiment, the data and/or instructions relating to or for the user interface controls that are separate to application program code are not stored on the electronic device, but are stored elsewhere, preferably remote from the electronic device, for example (and preferably) on a content server of or accessible via a communications network to which the electronic device can connect. Thus the set of data and/or instructions relating to or for the user-interface controls that is stored separately to the program code for the application is preferably stored on the network (server) side of the system, preferably, as a content file or files on (and that can be served by) a content server or servers of or accessible via a communications network. This facilitates, e.g., processing the user-interface controls in a distributed fashion (e.g. where the user-interface components are arranged in a distributed fashion).

Thus, in a particularly preferred embodiment, application program code is stored on the device itself (the client side), but at least some (and preferably, some but not all) of the data and/or instructions relating to or for the user interface controls for providing the user interface for the application are stored remotely to the device, and preferably on a communications network (server) side, e.g. and preferably, on a content server of or accessible via the communications network. Most preferably, the data and/or instructions relating to or for the user interface controls that are stored on the network (server) side are also processed on the network (server side) (e.g. and preferably by a user-interface component or components that are arranged, e.g., on a server or servers or platform or platforms, on or accessible via the communications network).

It is again believed that such an arrangement may be new and advantageous in its own right. Thus, according to a sixteenth aspect of the present invention, there is provided a system for providing user-interface functions for an application that is to be executed on an electronic device, the system comprising:

means, on or accessible via a communications network to which the electronic device is or can be connected, for storing a set of data and/or instructions relating to or for user-interface controls for providing user-interface functions and/or operations for the application.

According to a seventeenth aspect of the present invention, there ‘is provided a method of providing ’ user-interface functions for an application that is to be executed on an electronic device, the method comprising:

storing on, or so as to be accessible via, a communications network to which the electronic device is or can be connected, a set of data and/or instructions relating to or for user-interface controls for providing user-interface functions and/or operations for the application.

As will be appreciated by those skilled in the art, these aspects and embodiments of the invention can and preferably do include any one or more or all of the preferred and optional features of the invention described herein. Thus, for example, the data and/or instructions relating to or for the user-interface controls that are stored on the network (server) side are preferably also processed (so far as possible) on the network (server) side, and are preferably stored in a content server of or accessible via the communications network infrastructure. Thus there is preferably also provided, on the communications network, means for or a step of processing one or more or at least some of the data and/or instructions relating to or for the user-interface controls that are stored on or accessible via the communications network. It is also similarly preferred for there also to be a set or sets of data and/or instructions relating to or for the user-interface controls stored on the electronic device, preferably with or as part of the application (and at least some of which preferably are to be executed on the electronic device).

In these aspects and embodiments of the invention, there is preferably provided a user interface component, preferably and where appropriate on the network infrastructure (server) side, that can and will monitor the execution of an application and fetch and cause to be processed accordingly the separately stored (data and/or instructions relating to or for the) user interface controls as the application proceeds. For example, this “interaction manager” user-interface component could and preferably does have an event queue and an event loop (and action listeners) to which the application posts interaction events, and which can and will then access content servers that store the (data and/or instructions relating to or for the) user interface controls (e.g. defined as XML tags into XML content files) required according to the application business logic at any given time in response to the posted events. This user-interface component is preferably provided as or on a platform (e.g. server) of or accessible via the communications network (e.g. as part of a user-interface function providing platform on or accessible via the communications network).

In other words, where user interface controls for an application such as a game are provided separately to the application code, in separate, network-distributed content files (rather than being “embedded” in the application content itself), there is preferably a user-interface component that can as the application proceeds, fetch and process appropriately the relevant associated user interface control content files that include definitions of user-interface controls. This could be, e.g., triggered by the application or user-interface component recognising certain events.

For example, and preferably, the user-interface component on the, e.g., network side, will receive interaction events (e.g. from the application), and in response thereto (as an action) fetch the user-interface controls resources from the appropriate content server(s), which action will then generate further interaction events and actions, such as voice prompts to the user, etc.

In these arrangements, the user-interface component on the network side preferably processes the user-interface controls in the user-interface control content files that it fetches in a similar manner to the content proxy arrangement discussed above.

Thus, this interaction management user-interface component preferably can and preferably does (or comprises means to) identify user interface controls, such as voice tags, speech recognition grammars, etc., specified in the (web) content (page(s)) it fetches (that are served from the content servers), and preferably can, preferably selectively, process or cause to be processed one or more user interface controls in the content, e.g., and preferably, any user interface controls in the content that are applicable to the server side. In other words user interface controls in the content are preferably processed by the user-interface component.

Most preferably this interaction management user-interface component can identify and process or cause to be processed, (data and/or instructions relating to or for) user interface controls in the fetched content that are relevant to or required by user-interface components that are arranged on the network (server) side of the system. This could be done, e.g., by the component identifying interaction events and then triggering appropriate actions, in response thereto. In a preferred arrangement, this interaction management user-interface component can and does accordingly identify and process data and/or instructions relating to or for the user-interface controls in the fetched content relating to speech-based, and/or non-visual, user-interface modes, such as voice tags, speech recognition grammars, etc.

Thus, in a particularly preferred embodiment of the present invention, like the content proxy, this interaction management user-interface component is able to identify, and, most preferably, to process in some way, user interface controls (such as user interface related commands or data, etc.) that are specified in the content or resources that it fetches from a content server. Thus, this component preferably includes means for or can perform steps of retrieving content including data and/or instructions relating to or for the user interface controls from content server(s) on or accessible via the communications network and then acting upon, and/or providing to an electronic device the (data and/or instructions relating to or for the user interface controls, content etc., as appropriate.

In these arrangements, the “interaction manager” user-interface component can similarly process the user interface controls it identifies in any appropriate and desired manner. In a particularly preferred embodiment, it can execute user interface controls that are specified in the content it retrieves, most preferably by publishing interaction events in response to those user-interface controls (which interaction events can then be detected by and responded to by other user-interface components, e.g. on the server side). For example, in the case of a speech recognition grammar user-interface control, it could, upon recognition of such a user-interface control, post an interaction event to activate the necessary resources for recognising the speech, or, in the case of providing a spoken prompt, post events to trigger the fetching or generating of the relevant spoken prompt for provision to the electronic device by the appropriate user-interface components. Thus, this user-interface component preferably processes the user interface controls by generating (or publishing) the relevant (corresponding or associated) interaction events.

In other words, this interaction management user interface component can preferably execute user-interface controls specified in content (pages) that it fetches, and most preferably does so by publishing interaction events in response to user-interface controls in the content (which events are passed to other user-interface components, which then execute actions and trigger new events in response thereto, and so on). Thus, it preferably can and preferably does trigger interaction events in response to (data and/or instructions relating to or for) user-interface controls in the content.

The effect of this is that this interaction management user-interface component can and will execute part of the user-interface function and operation, and will, in effect, coordinate and orchestrate user-interface functions on the server (network) side of the system (by publishing interaction events to trigger operations of user-interface components on the server side, fetch resources on the server side, etc.).

In a preferred embodiment this interaction management user-interface component can also or instead remove or filter some or all of the data and/or instructions relating to or for the user interface controls from the fetched content and/or resources and then provide the so-filtered content to an electronic device (it may still be desirable for some of the data and/or instructions relating to or for the user-interface controls in the content file to be provided to the electronic device, as the content file could, e.g., also be used to store remotely and/or in a distributed fashion user-interface controls to be executed on the electronic device). This would allow the user-interface component to, in effect, separate the user interface controls that it will effect from the content and/or resources required by the electronic device before the content and/or resources is provided, to the device.

It should be noted here that the application may and preferably does still itself post interaction events. Similarly, the application preferably will specify or have associated with it some user-interface controls (and thus, e.g., and preferably, there may be some user-interface controls, such as visual and keyboard controls, that remain at the application code, with other controls being specified in content files on the network with the two sides communicating with each other, e.g., and preferably, as discussed above).

In these arrangements, the user-interface controls and the processing of user-interface controls, and interaction events, are, in effect, distributed as between, e.g., the electronic devices themselves, and user-interface components, etc., on the network (server) side of the system. This has the advantage of, as discussed above, facilitating multimodal user-interfaces for applications, distributing user-interface functions, etc., across a communications network for applications, etc. For example, it allows the appropriate resources to be arranged closer to distributed user-interface components, thereby improving latency times. It also means that user-interface components can be independent of particular applications and devices, thereby, e.g., enabling user-interface components to be shared across plural applications, and across multiple devices, thereby making it easier to provide multimodal user-interfaces to multiple devices and applications. It also allows user-interface controls to be stored other than on the electronic device itself, thereby, e.g., no longer consuming device resources (e.g. memory Capacity) and no longer being constrained by the device's available resources.

It is again believed that the above arrangements may be new and advantageous in their own right. Thus, according to an eighteenth aspect of the present invention, there is provided a method of providing user interface functions to or for an electronic device, comprising:

storing on a content server accessible via a communications network a set of data and/or instructions relating to user interface functions of or for'an electronic device;

an electronic device communicating an interaction event to a user-interface component that is separate from the electronic device; and

the user-interface component, in response to the interaction event from the electronic device, retrieving from the content server data and/or instructions relating to or for a user interface function or functions, and processing that data and/or instructions to provide a user interface function for or to the electronic device.

According to a nineteenth aspect of the present invention, there is provided a system for providing user interface functions of or for an electronic device, comprising:

a content server accessible via a communications network for storing a set of data and/or instructions relating to user interface functions of or for an electronic device; and

a user-interface component comprising:

means for receiving and processing an interaction event from an electronic device; and

means for, in response to an interaction event from an electronic device, retrieving from the content server data and/or instructions relating to or for a user interface function or functions, and means for processing that data and/or instructions to provide a user interface function of or for the electronic device.

According to a twentieth aspect of the present invention, there is provided a user-interface component for providing user interface functions to or for an electronic device of or on or using a communications network, the user-interface component comprising:

means for receiving from an electronic device an interaction event;

means for, in response to an interaction event received from an electronic device, retrieving data and/or instructions relating to or for a user interface function or functions from a content server accessible via the communications network; and

means for processing the retrieved data and/or instructions to provide a user interface function of or for the electronic device.

As will be appreciated by those skilled in the art, these aspects and embodiments of the invention can and preferably do include any one or more or all of the preferred and optional features of the invention described herein. Thus, for example, the data and/or instructions relating to user interface functions preferably comprises user interface controls, such as data or commands, as discussed above. There may be one or more than one such sets of data. Similarly, the user-interface component is preferably arranged on the communications network and/or includes and is part of a distributed interaction queue, etc., arrangement, as discussed above.

Thus, for example, the component or components for providing the user-interface functions are preferably provided on or are accessible via a communications network to which the electronic devices can connect (and are thus arranged on a network (server) side of the system). The component or components similarly also preferably execute the user interface controls, and preferably generate (publish) interaction events in response to the user-interface controls, for example to trigger speech recognition grammars or the provision of speech prompts to the electronic device. It or they can preferably also identify and remove user interface controls in the content fetched from a content server, and provide the so-modified content to an electronic device. These user-interface components similarly preferably have an interaction event queue or queues, etc., associated with them, as discussed above.

In these aspects and arrangements, the system could and preferably does operate by interaction events reaching the “interaction manager” user-interface component, e.g., via a distributed interaction queue arrangement, with the interaction manager user-interface component then fetching, in response to interaction events, content files which specify user-interface controls from a content server or servers. The interaction manager user-interface component will, then arrange and process the user-interface controls in the fetched content files, e.g. to generate new interaction events to be handled by other user-interface components, such as speech recognition engines, etc.

As will be appreciated from the above, in preferred embodiments of the above preferred arrangements of the present invention, whether for a browsing application or a terminal application, there will be one or more content servers that will store resources required to set up user-interface controls and action listeners during the user-interaction process. These resources will include definitions of user-interface controls, such as prompts, recognition grammars, etc., and will be requested by appropriate user-interface components, such as the content proxy and/or the “interaction manager” user-interface component, etc., as required.

Similarly, the content proxy and interaction manager user-interface components discussed above are similar components that have similar functions. They are both user-interface components that can fetch content from content servers and, if desired, process at least some of that content (e.g., and preferably, user-interface controls included in that content). The difference is that the content proxy is capable of interacting in a network communication (from the browser to the content server), whereas the “interaction manager” does not (it fetches the content by itself in response to events).

As will be appreciated by those skilled in the art, these user-interface components could be implemented as separate components or could be in the form of a single component that can provide all this functionality. They are also preferably located or arranged on a server or servers of the communications network. It would also be possible, e.g., for there to be plural such content proxy and interaction management user-interface components in the system, and, e.g., distributed over the communications network.

Thus, in a preferred arrangement of the present invention for use in or with a communications network, there will be one or more content servers on or accessible via the network for providing user-interface controls (the resources required for user-interface controls) for (e.g. applications of) terminal devices of the network, and one or more network-based user-interface components that can fetch the user-interface controls from the content servers, and, preferably, process some of the fetched controls. The network-based user-interface components preferably include a component or components that can act as a proxy for content requests of a browser of a terminal device (a content proxy as discussed above) or, or most preferably and, that can react to application events and fetch user-interface control content pages appropriately. Preferably these components are arranged on or as a platform on the communications network.

It is again believed that these various arrangements may be new and advantageous in their own right.

Thus, according to a twenty-first aspect of the present invention, there is provided a method of providing user-interface functions to or for an electronic device, the method comprising:

storing separately to the electronic device a set of data and/or instructions relating to user-interface functions of an electronic device; and

retrieving the stored data and/or instructions relating to user-interface functions using a user-interface component that is separate to the electronic device, but which can communicate with the electronic device.

According to a twenty-second aspect of the present invention, there is provided a system for providing user-interface functions of or for an electronic device, the system comprising:

means for storing separately to the electronic device a set of data and/or instructions relating to user-interface functions of an electronic device; and

means for retrieving the stored data and/or instructions relating to use-interface functions using a user-interface component that is separate to the electronic device, but which can communicate with the electronic device.

According to a twenty-third aspect of the present invention, there is provided a component for providing user-interface functions to or for an electronic device, the component comprising:

means for fetching data and/or instructions relating to user-interface functions for an electronic device from a content server or servers that is separate to the electronic device; and

means for communicating with the electronic device.

As will be appreciated by those skilled in the art, these aspects and embodiments of the invention can and preferably do include any one or more or all of the preferred and optional features of the invention described herein, as appropriate. Thus, for example, the data relating to user-interface functions preferably comprises at least some user-interface controls and preferably can be and preferably is processed on or by the component that is separate to the electronic device (and that component accordingly preferably further includes means for processing retrieved user-interface control data and/or instructions to provide a user-interface function or operation for the electronic device, for example, and preferably, in the manner or manners discussed above).

Similarly, the system preferably operates by interaction events reaching the user-interface component, e.g. via a distributed interaction queue arrangement, with the user-interface component then fetching, in response to interaction events, content files which specify user-interface controls from a content server or servers, and using the user-interface controls in the fetched content files to generate new interaction events to be handled by other user-interface components.

Equally, the component that is separate to the electronic device can in one preferred arrangement act as a content proxy for browsing requests made by a browser of the electronic device.

The component for providing the user-interface functions also most preferably has an interaction event queue and/or event loop, preferably that can act as a distributed event queue, as discussed above. The data relating to user-interface functions is similarly preferably stored on one or more content servers that can be accessed by the user-interface component.

According to a twenty-fourth aspect of the present invention, there is provided a system for providing user-interface functions of or for electronic devices that can communicate with a communications network, the system comprising:

a communications network via which electronic devices using the network can communicate with other devices on or that are part of the network;

one or more content servers on or accessible via the communications network for storing data and/or instructions relating to user-interface functions for electronic devices on or using the network; and

one or more components arranged on the network that can communicate with electronic devices using the network and that can retrieve user-interface data and/or instructions from the content servers so as to provide user-interface functions and operations to electronic devices via the communications network.

According to a twenty-fifth aspect of the present invention, there is provided a method of providing user-interface functions of or for electronic devices that can communicate with a communications network via which electronic devices using the network can communicate with other devices on or that are part of the network, and which network comprises one or more content servers on or accessible via the communications network for storing data and/or instructions relating to user-interface functions for electronic devices on or using the network; the method comprising:

using one or more components arranged on the network that can communicate with electronic devices using the network to retrieve user-interface data and/or instructions from the content servers so as to provide user-interface, functions and operations to electronic devices via the communications network.

According to a twenty-sixth aspect of the present invention there is provided a system for providing user-interface functions to or for electronic devices of or using a communications network, comprising a user-interface component platform that is arrangeable on or as part of the communications network infrastructure and that comprises:

one or more user-interface components that can communicate with electronic devices using the network and that can retrieve user-interface data and/or instructions from content servers so as to provide user-interface functions and operations to or for electronic devices via the communications network.

As will be appreciated by those skilled in the art, these aspects and embodiments of the invention again can and preferably do include any one or more or all of the preferred and optional features of the invention described herein, as appropriate. Thus, for example, the user-interface data and/or instructions preferably specifies at least some user-interface controls. Similarly, the user-interface components preferably can process and include means for processing retrieved user-interface control data and/or instructions to provide a user-interface function or operation for an electronic device.

Similarly, in a preferred embodiment of these aspects and arrangements of the invention, the system operates by interaction events reaching the user-interface component, e.g., via a distributed interaction queue arrangement, with the user-interface component then fetching, in response to interaction events, content files which specify user-interface controls from a content server or servers, and using user-interface controls in the fetched content files to generate new interaction events to be handled by other user-interface components.

In these embodiments and aspects of the invention, there is preferably a user-interface component, or user-interface components that can communicate with electronic devices using the network and that can retrieve user-interface data from content servers so as to provide user-interface functions and operations to electronic devices via the communications network, which can act as a content proxy for browsers of electronic devices, and also not act as a content proxy, but fetch (and preferably process) user-interface data for non-browser applications of electronic devices, such as, and preferably, terminal applications of electronic devices.

As well as these user-interface components, there are preferably other user-interface components provided on the network side (e.g. and preferably on the platform), such as a speech recognition engine, a text to speech renderer, etc. Each user-interface component preferably has associated with it an interaction event queue, etc., as discussed above, which queues are preferably arranged in a distributed fashion, as discussed above.

The various user-interface components may be arranged in a distributed fashion on the network side, e.g., across several servers on or accessible via the network, or may, e.g., be arranged on a common platform (e.g. single server or group of servers of the or accessible via the network).

As will be appreciated by those skilled in the art, the present invention can be used to and is applicable to use to, provide user-interface functions, etc., for a plurality of devices and applications at the same time. Indeed, an important advantage of the present invention is that it facilitates the provision of user-interface functions to plural devices simultaneously and in a shared manner. In such arrangements, there may be, for example, plural user interface components, each, e.g., maintaining an event queue, distributed across the communications network and each providing user-interface functions to one or more electronic devices.

In order to further facilitate such operation, the system (e.g. a or some or all of the user-interface components) can preferably maintain a session (i.e., as is known in the art, a set of current data and parameters) for a and preferably for each application or interaction (or at least for each currently and/or recently active application or interaction) that is proceeding (and for any given electronic device). Such a session preferably, e.g., maintains an up-to-date record of the current interaction parameters and data for a given application or interaction, etc., as is known in the art. Thus, each session preferably includes information required by currently active user-interface controls, such as the text in a text box, the last spoken prompt, a user expertise value, etc. As is known in the art the data stored in the session could in practice be anything that is required to run the user-interface component in question.

In a particularly preferred embodiment, the system can maintain a plurality of sessions concurrently. Preferably a session can be maintained for the or each application that is active on a given electronic device (and most preferably for each electronic device). Most preferably, sessions are maintained per user with sub-sessions being maintained per application running for each user. In a preferred embodiment, each user-interface component has associated with it or access to such session information (sessions).

Sessions may be maintained, e.g., for a group of user-interface components in common, but in a particularly preferred arrangement, each user-interface component has session storage, and preferably maintains a session for each user that is using that user-interface component, with each such session preferably having a sub-session for each application that is in use.

In a particularly preferred embodiment, the system (e.g., and preferably, a and preferably each user-interface component) can maintain, in respect of a given electronic device, a session that is to be used in common for all concurrently running applications of a user and/or device (which session could, e.g., maintain data that will be used for and common to all the applications, such as data relating to the communications link between the network and device), together with a separate session (a sub-session) for each individual application (relating to, e.g., more application specific data) running (in use) for the user and/or device. This has been found to be an efficient and effective way of handling plural simultaneous applications.

Indeed, it is believed that such an arrangement may be new and advantageous in its own right. Thus, according to a twenty-seventh aspect of the present invention, there is provided a method of maintaining session data for a plurality of applications, the method comprising:

maintaining a session to be used for a plurality of applications in common; and

maintaining a separate session for each individual application in the plurality of applications.

According to a twenty-eighth aspect of the present invention, there is provided an apparatus for maintaining session data for a plurality of applications, the apparatus comprising:

means for maintaining a session to be used for a plurality of applications in common; and

means for maintaining a separate session for each individual application in the plurality of applications.

Again, these aspects of the invention can and preferably do include any one or more or all of the preferred and optional features of the invention described herein, as appropriate.

In these arrangements, as discussed above, the sessions are preferably maintained on a or plural user-interface components arranged on the communications network (on the server side) and/or on the electronic devices themselves. Thus, in a particularly preferred arrangement, each user-interface component can maintain a common session for plural applications (e.g. for each user and/or electronic device), and preferably sub-sessions for individual applications. This, in effect, will store the sessions in a distributed fashion, similarly to the interaction event queues, as discussed above (since each such session will, effectively, store the same or similar data).

Thus, in a particularly preferred embodiment, sessions can be and are maintained both on the individual electronic devices and on the communications network (server) side, and a distributed session arrangement is preferably maintained (similarly to the distributed interaction queue arrangement discussed above). In this arrangement there will be and preferably is a session maintained, e.g., for plural applications in common and individually, at or for plural different user-interface components. Each session should, as will be appreciated by those skilled in the art, store the same or similar session information, and so the plural different sessions will, in effect, act as a distributed, single “virtual” session, e.g., for the device in question.

Each session may, e.g., store local and/or global session information, and the individual sessions are preferably synchronised with each other (their data kept up to date) at appropriate events or intervals.

Maintaining a distributed session or sessions in this manner facilitates, e.g., applications and network components sharing information more easily. Again, a “common” session and individual sessions for separate applications of a given electronic device and/or user are preferably maintained.

It will also be appreciated that an effect of this is that a session will be (and preferably is) maintained both'on the individual electronic devices and on the communications network (server) side, since there may be user-interface components that maintain sessions on both the client and server sides.

Indeed, it is believed that such an arrangement may be new and advantageous in its own right. Thus, according to a twenty-ninth aspect of the present invention, there is provided a method of maintaining session data for electronic devices of or using a communications network, the method comprising:

maintaining plural sessions in a distributed fashion.

According to a thirtieth aspect of the present invention, there is provided an apparatus for maintaining session data for electronic devices, the apparatus comprising:

means for maintaining plural sessions in a distributed fashion.

Again, these aspects of the invention can and preferably do include any one or more or all of the preferred and optional features of the invention described herein, as appropriate. Thus, for example, the sessions are preferably maintained on or associated with plural user-interface components arranged on a communications network (on a server side) and/or on the electronic devices themselves. Similarly, each user-interface component can preferably maintain or has associated with it a session for each user and/or electronic device, and preferably for individual applications.

In the arrangements and aspects of the present invention, the electronic device or devices of the system can be any suitable such devices, but are preferably a communications device or devices, such as a communications terminal or terminals. They are most preferably mobile or portable and/or wireless devices, such as mobile communications devices or terminals. As will be appreciated by those skilled in the art, and as discussed above, there will typically be, and indeed, preferably is, a plurality of electronic devices in the system, of which one or more can be provided with user interface functions at any one time.

In a preferred embodiment, the electronic device(s) and/or communications device(s) comprise, e.g., mobile ‘phones, PDAs, in-car systems, etc. The electronic and/or communications devices could also be other devices that can communicate with a communications network, such as personal computers (whether desktop or laptop), and more general household appliances that include some form of electronic control, such as washing machines, cookers, TVs, hi-fis, etc.

The system of the present invention may be used to support and provide user-interface functions to any desired and suitable applications, such as games, (Internet) browsing applications, and/or communications terminal-based applications. The applications preferably comprise applications that will or can use a multi-modal user interface, such as games, phone books, calendars, etc., and (Internet) browsing applications. The applications could comprise, e.g., JAVA and C++ applications.

The applications may, as is known in the art, run and be executed, e.g., mainly on the electronic device itself, mainly on a server or servers and/or host platform or platforms of or accessible via a communications network, or be distributed between two or more such components.

It will be appreciated that in arrangements of the present invention, a number of different applications may be usable (e.g. running concurrently) on a given electronic device at any one time. Thus, in a particularly preferred embodiment, a or the and preferably each electronic and/or communications device can identify, and includes means for identifying, which application is currently active (i.e. being used by the user). This can be done in any suitable manner, for example by identifying which application's window is in the foreground or background, as is known in the art.

In a particularly preferred such arrangement, the foreground or background presence of an application are implemented as interaction events, such that, e.g., when an application goes foreground, the user-interface component involved in that transition can then publish an interaction event to that effect to enable the other user-interface components to know about it, etc.

In these arrangements (and otherwise) interaction events may and preferably do identify the application they relate to (e.g. to facilitate application concurrency). Similarly, user-interface components preferably can and preferably do handle interaction events differently, depending on their nature and whether they relate to an application in the foreground or not.

Thus, the identity of the currently active application is preferably used to control subsequent processes of the system, e.g. processes performed by user-interface components, and the identity of the active (foreground) application is most preferably provided to some or all of the user-interface components of the system. This would allow, e.g., user-interface components to activate the, e.g., user-interface resources for the currently active application, and to stop or put on hold resources for “non-active” applications.

It may also be appropriate, for example, to send certain interaction events (such as recognition events) to user-interface components related to applications that are in the foreground only, whereas other interaction events (such as, for example, interaction events relating to user expertise or mood measures, environmental conditions information, etc.) may still be received by (and useful to) all user-interface components, regardless of whether they are related to applications that are in the foreground or background. Thus, preferably the recipients of interaction events are or can be selected based on which application is currently active (and/or in the foreground). As discussed above, the use of publish-subscribe signalling as in the preferred embodiments of the present invention facilitates such arrangements.

The identity of the currently active (foreground) application is also preferably used to access and control the application sessions that are maintained by the system, for example to store and/or retrieve current session status for the different applications, as appropriate. For example, when there is a change in the currently in use (the foreground) application, the recognition of this could be used to retrieve the last played voice prompt for the new application from the session for the new application for replaying to the user.

Implementing application foreground and background transitions as interaction events in this manner, together with, e.g., maintaining a session per user-interface component with information about each application, facilitates the user-interface components handling subsequent interaction events appropriately.

It is believed that such arrangements may be new and advantageous in their own right. Thus, according to a thirty-first aspect of the present invention, there is provided a system comprising:

one or more electronic devices on which plural applications can run concurrently;

a communications system infrastructure; and

one or more components on or accessible via the communications system infrastructure for performing one or more functions or tasks for providing user interface functions of or for the electronic devices; wherein:

the or each electronic device comprises means for identifying the application on the device that is active or in the foreground, and means for providing that information to one or more of the components for performing one or more functions or tasks for providing user interface functions for the electronic devices.

According to a thirty-second aspect of the present invention, there is provided a method of operating a system comprising one or more electronic devices on which plural applications can run concurrently, a communications system infrastructure, and one or more components on or accessible via the communications system infrastructure for performing one or more functions or tasks for providing user interface functions of or for the electronic devices; the method comprising:

an electronic device identifying the application on the device that is active or in the foreground, and providing that information to one or more of the components for performing one or more functions or tasks for providing user interface functions for the electronic devices.

Again, these aspects of the present invention, as will be appreciated by those skilled in the art, can, and preferably do, include any one or more or all of the preferred and optional features of the invention described herein, as appropriate.

The communications system or network that the present invention is applied to or incorporated in can be any suitable such network. In a preferred embodiment, as will be appreciated by those skilled in the art, it is a mobile communications network, such as a GSM, GPRS or 3G, etc., network. However, the present invention is also applicable to other arrangements where electronic devices can communicate with a communications network, such as Internet-based systems and networks, interactive television (iTV) systems and networks, suitable embedded systems and networks, etc.

The system or network itself can be implemented in any appropriate manner, for example by having appropriate servers in or accessible via the network. There could also be, e.g., more than one user-interface component (and/or component platform), content server, on the network infrastructure side, etc., as desired. For example, the user-interface components on the network side could be arranged on a single platform, or distributed across the network. There could also be, for example, plural user-interface component platforms, each having the same or different sets of user-interface components.

There could also be, for example, one network for browsing functions and applications and another network for signalling and (e.g. point-to-point) real time media connections, etc. There may be, for example, multimedia connections between user-interface components that are used to send and receive “media payloads”, such as audio, video, etc. The signalling (“signalling payloads”) may then, e.g., be tunnelled over these multimedia connections, as appropriate.

It would also be possible to have more than one tunnel arrangement for distributing the user-interface among more than one client and/or server side device.

It would also, for example, be possible for there to be intermediate components in communications paths between elements and components that are relevant to the present invention. For example in browsing network connections there could, e.g., be intermediate network elements, such as caches, gateways, WAP gateways, storage elements, etc., between the browser on the client device and the content proxy, etc. Similar comments apply in relation to signalling tunnels and point-to-point media connections between user interface components, etc. Thus the present invention does not require there to be direct connections between elements of the system of the present invention (although in some cases this may be preferred).

As will be appreciated by those skilled in the art, all of the aspects and embodiments of the invention described herein can and preferably do include any one or more or all of the preferred and optional features of the invention described herein, as appropriate.

The methods in accordance with the present invention may be implemented at least partially using software e.g. computer programs. It will thus be seen that when viewed from further aspects the present, invention provides computer software specifically adapted to carry out the methods herein described when installed on data processing means, a computer program element comprising computer software code portions for performing the methods herein described when the program element is run on data processing means, and a computer program comprising code means adapted to perform all the steps of a method or of the methods herein described when the program is run on a data processing means. The invention also extends to a computer software carrier comprising such software which when used to operate a communications system comprising data processing means causes in conjunction with said data processing means said system to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is, contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of preferred embodiments of the present invention will now be described by way of example only, and with reference to the accompanying drawings, in which:

FIG. 1 shows schematically an event queue arrangement of a system for providing user-interface functions to an electronic device;

FIG. 2 shows schematically a distributed event queue arrangement that is in accordance with the present invention;

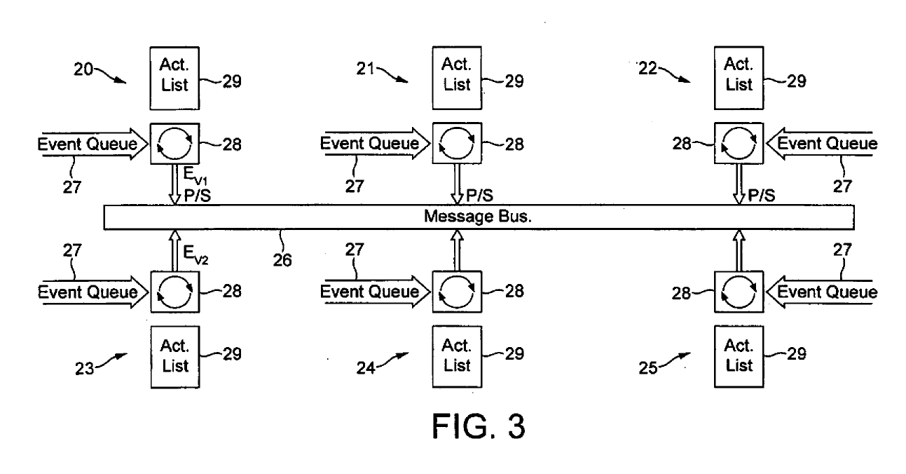

FIG. 3 shows another embodiment of a distributed event queue arrangement that is in accordance with the present invention;

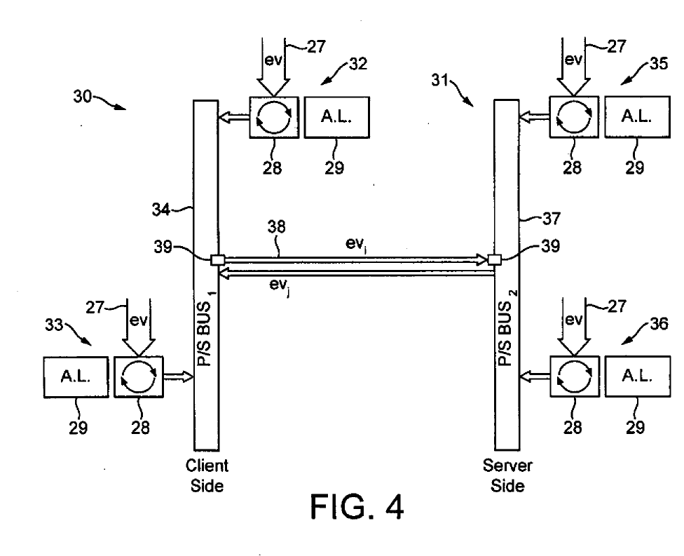

FIG. 4 shows a further embodiment of an event queue arrangement that is in accordance with the present invention;

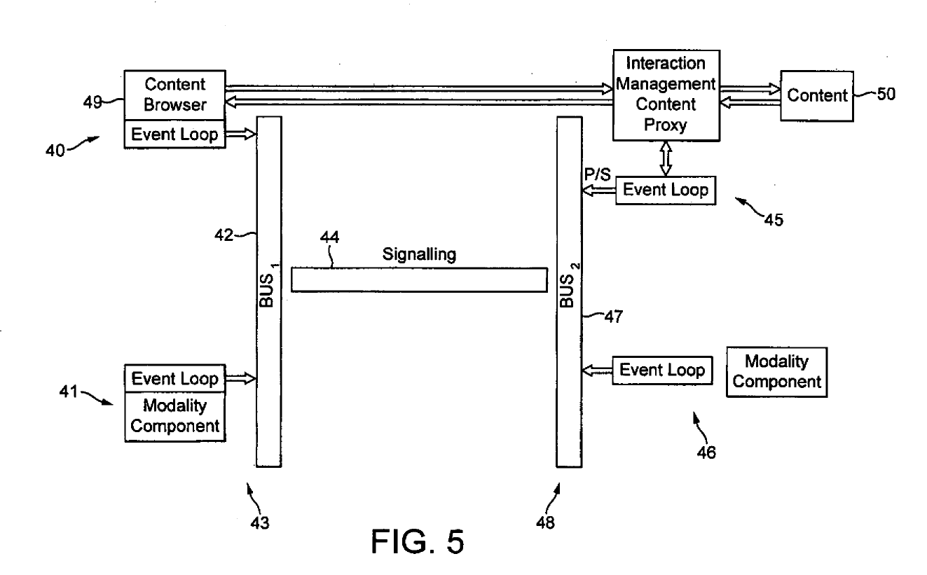

FIG. 5 shows schematically another embodiment of a system for providing a user interface functions to an electronic device that is in accordance with the present invention;

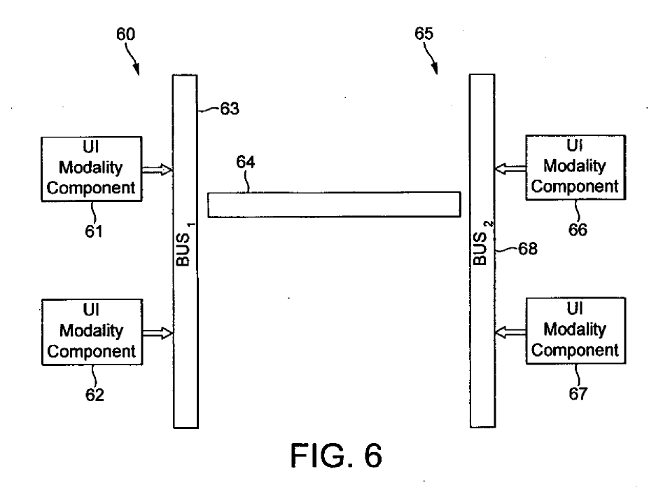

FIG. 6 shows a further embodiment of a system for providing user-interface functions to an electronic device;

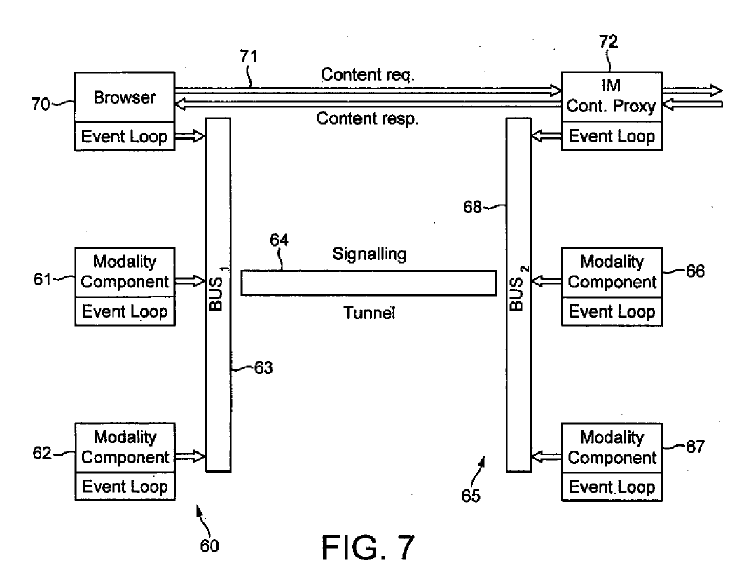

FIG. 7 shows a yet further embodiment of a system for providing user-interface functions to an electronic device that is in accordance with the present invention; and

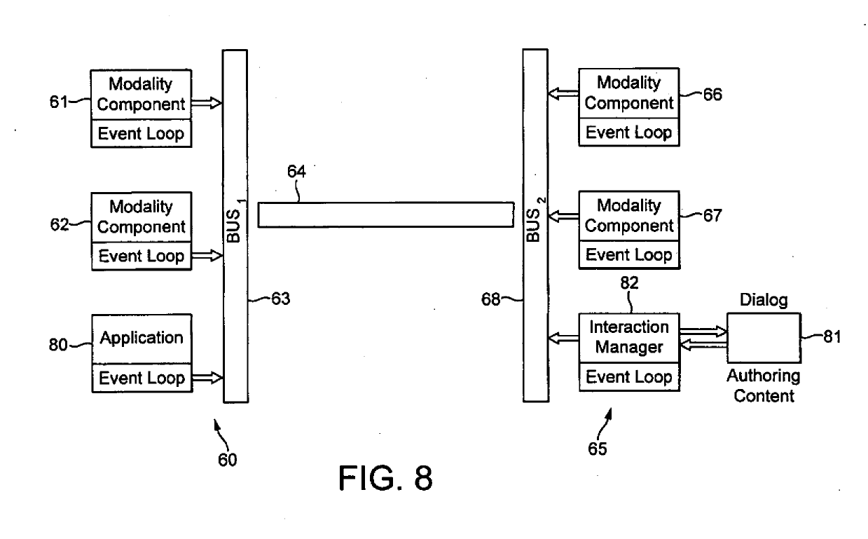

FIGS. 8, 9, 10 and 11 show further embodiments of systems for providing user-interface functions to an electronic device that are in accordance with the present invention.

Like reference numerals indicate like components in the Figures.

The present invention, as discussed above, relates, e.g., to the provision of multi-modal and in particular speech-enabled user interfaces for user devices and terminals of a communications system.

In a multi-modal user-interface, there will be a number of user-interface components or modules, such as a keyboard or keypad, a screen, a speech recognition engine, a graphics rendering engine, a text-to-speech rendering engine, the business applications, that are being executed on an electronic device, etc. These components, as discussed above, in the present embodiments, each act as “event-based” services that notify and post user-interaction events and respond appropriately thereto to modify the user-interface and/or its behaviour.

FIG. 2 shows a first embodiment of an arrangement that is in accordance with the present invention. In this arrangement, two user-interface components 10, 11 are shown schematically as having their own individual event queues 12, 13, event checking loops 14, 15, and “action listeners” 16, 17, respectively. In this arrangement, each user-interface component 10, 11, identifies and detects user-interaction events and posts those events to its own respective event queue, which then proceeds to process those events accordingly.

The two event queues 12, 13 are also linked via a one-to-one communications channel 18, over which events evᵢ, evⱼ, posted at one queue can be sent to the other, remote queue, as desired. In particular, the event loops 14, 15, choose and determine which events that are posted to their respective event queues should also be sent to the other, remote event queue via the communications channel 18.

The interaction event queues 12, 13 are further arranged such that when an interaction event happens at one or other queue, any appropriate user interface actions that are possible at the respective queue (i.e. at the user interface component where the event has occurred) are executed immediately, and at the same time the event is reported (if appropriate) to the interaction queue at the other user-interface component.

In this way, a distributed interaction queue is in effect maintained, and delays between events and responses are reduced, since user interface actions can be activated at one side of the system (i.e. in one user interface component), without any need to wait for the other user interface component to have first been updated with the event that has occurred.

FIG. 3 shows a second arrangement of a distributed interaction queue that is in accordance with the present invention. In the arrangement shown in FIG. 3, there are again plural user-interface components 20, 21, 22, 23, 24 and 25, each of which again have their own event queues 27, event loops 28 and action listeners 29. The event queues of the user-interface components can again communicate with each other via a communications message bus 26.

However, in this embodiment, the message bus 26 is not arranged as a one-to-one communication channel between respective user-interface components, but instead is in the form of & publish-subscribe bus. In other words, the message bus 26 is arranged such that messages and communications sent via the bus 26 include a subject or identifier that can be used by the other user-interface components coupled to the bus to decide to receive (to subscribe to) the message or communication or not. This arrangement facilitates, in particular, the sending of a single message (e.g. interaction event notification) to plural target user-interface components simultaneously. Interaction events can be sent as XML messages on the publish subscribe bus 26 using for example, real-time communication protocols. Other arrangements would, of course, be possible.

FIG. 4 shows a further distributed interaction event queue arrangement that is in accordance with the present invention.

The arrangement in FIG. 4 shows schematically a system comprising a “client side” 30, which may, for example, comprise an electronic device or communications terminal of a communications network, and a server side 31, which may comprise, for example, a platform or server on a communications network to which the communications terminal 30 belongs.

As shown in FIG. 4, on the client side, there is an arrangement of plural user-interface components 32, 33 that communicate with each other via a publish subscribe bus 34, in the same manner as discussed above in relation to FIG. 3.

There is then a similar arrangement of user-interface components 35, 36 having event queues 27 and event loops 28, etc., on the server side 31 that communicate via a publish subscribe bus 37 on the server platform.

In the arrangement shown in FIG. 4, the internal publish subscribe message bus 34 on the client side (terminal device) and the internal publish subscribe message bus 37 on the server side (communications network infrastructure side) are coupled to each other by tunnelling appropriate published messages using a suitable signalling protocol, such as session initiation protocol, over an existing communications channel 38 of the communications network. This provides, in effect, a virtual, end-to-end publish subscribe message bus that connects the relevant user-interface components and event queues on the client side 30 and the server side 31, and allows those user-interface components and event queues the ability to communicate one-to-one or one-to-many with each other in real-time. (Other arrangements would, of course, be possible.)

In order to facilitate this arrangement, a signalling tunnel component 39 is arranged at each end of the tunnel 38 that can select which messages are to be sent to the other end of the tunnel and that carries out the necessary protocol conversion (e.g. to subscribe to a message from the bus and transmit it to the other end of the tunnel via a signalling protocol, or to receive a message from the tunnel via the signalling protocol and then publish the message on the publish-subscribe bus).

In effect, these signalling tunnel components 39 on the terminal device client side 30 and on the network server side 31 act to filter (and protocol convert) messages that they receive or are to send to the other side via the communications channel 38, so as, e.g., not to send across the communications channel 38 messages that are known not to be relevant to the other party. This filtering mechanism ensures that only relevant messages are passed between the terminal device client side 30 and the server (network) side 31.

FIG. 5 shows a further embodiment of a user-interface system that is in accordance with the present invention.

Again, in the arrangement shown in FIG. 5, there is a set of user-interface components 40, 41 linked via a publish subscribe bus 42 on a client or terminal side 43, which can communicate via a signalling channel 44, with a set of user-interface components 45, 46 linked, via a publish subscribe bus 47 on a server or network platform side 48 of the system. This arrangement operates in a similar manner to the arrangement described above with reference to FIG. 4.

As shown in FIG. 5, the system also includes a content browser 49 on the terminal device 43, which can send requests for, inter aria, Internet content from a content server 50 of the communications network infrastructure to the communications network side 48. As shown in FIG. 5, in order to facilitate such fetching or browsing content and its provision to the terminal device 43, an interaction management content proxy 45 is provided as one of the user-interface components arranged on the communications network side.

This content proxy 45 receives content requests from the content browser 49 of the terminal device 43, and passes those requests to the content server 50. The content server then returns the requested content to the content proxy 45. When it receives the returned content from the server 50, the content proxy 45 acts to identify user-interface controls that are specified in the web content (web pages), and then processes and passes those user interface controls (the data and instructions that specify them) (e.g. voice interaction elements) to other user-interface components and event queues on the communications network (server side) 48. It does this by publishing interaction events on the publish subscribe bus 47 in response to user-interface controls in the web content, which events are then subscribed by the other user-interface components 46 on the network (server side) 48, thereby triggering the appropriate interaction actions, etc. The remaining, e.g., visual, elements of the web content is then passed to the browser 49 of the terminal device 43 for display to a user.

This facilitates for example, providing and processing both visual and speech-enabled user-interface content to the terminal device 43, without the need for the terminal device 43 to perform any additional processing, etc., of that content.

FIG. 6 shows a further embodiment of the present invention.

The arrangement shown in FIG. 6 is similar to that shown in FIG. 4. Thus there is, for example, a terminal device 60 comprising plural user-interface components 61, 62, such as a keyboard and screen, that each have their own interaction event queues and are linked via a publish subscribe bus 63 on the terminal device 60. The terminal device is also in communication via a communications channel 64 of the communications network to which the terminal device 60 belongs, with a platform or server, etc., 65, arranged on the communications network infrastructure, which platform comprises further user-interface components 66, 67, such as an automatic speech recognition engine, a text-to-speech rendering engine, etc., each of which again have their own interaction event queues, and which are linked via a publish subscribe bus 68 on the server platform 65.

FIG. 7 shows another, similar arrangement. However, in the arrangement shown in FIG. 7, there is also shown on the terminal device 60 a user-interface component in the form of a browser 70 that can communicate via a communications channel 71 with a user-interface component in the form of a content proxy 72 of the type discussed above in relation to FIG. 5.

FIG. 8 shows another arrangement of a system for providing a user-interface for an electronic device such as a communications terminal 60 that is similar to the arrangement shown in FIG. 7.

However, in the arrangement shown in FIG. 8, there is also shown on the terminal device 60 a user-interface component in the form of a terminal application 80 that corresponds to, for example, an application, such as a game, that can be executed on the terminal 60.

In this arrangement, a content file or files that contain user-interface controls information for the terminal application 80 are stored on a content server 81 on the communications network infrastructure. Each such content file comprises an XML document that contains a set of user interface controls such as voice prompts, events, audio, and other interaction information (that are defined, e.g., as XML tags in the XML content files). The application 80 would typically have several such content files associated with it, each of which contain user-interface controls information and, e.g., can be activated as required during execution of the application. Similar arrangements can be provided for other applications that may be executed on or via the terminal device 60.

In order to facilitate this operation, the user-interface component platform 65 on the communications network includes an interaction management user-interface component 82 which is operable to retrieve and process the user interface control content files stored in the server 81 as the application 80 is executed.

In operation of this arrangement, as the application 80 is executed, the user-interface components of the system will publish and subscribe interaction events, such as recognition notifications. The interaction management user-interface component 82 on the interaction platform 65 will receive appropriate interaction events and then in response to those events retrieve the appropriate content files containing user-interface controls information from the content server 81, process the user interface controls, and then provide the desired interaction actions, data, etc., such as voice prompts, etc., to the terminal device 60, e.g. for broadcasting as the application 80 executes. This process is repeated as the application 80 proceeds, with, for example, new user interface control content files being retrieved and processed by the interaction management user-interface component 82 as events are published and subscribed by the user-interface components (including, e.g., the application 80 and/or other user-interface components on the terminal device 60 or on the network infrastructure).

The interaction management user-interface component 82 when it processes the user interface controls that it retrieves from the server 81 will, for example, extract relevant user interface controls, such as voice resource components, from a content file and publish them so that they can be subscribed (and then processed) by other user-interface components, such as voice resource user-interface components, such as an automatic text-to-speech rendering engine, on the server (network) side 65. It will also, for example, return any visual user-interface controls to the terminal device 60 via the tunnelling communications channel 64.

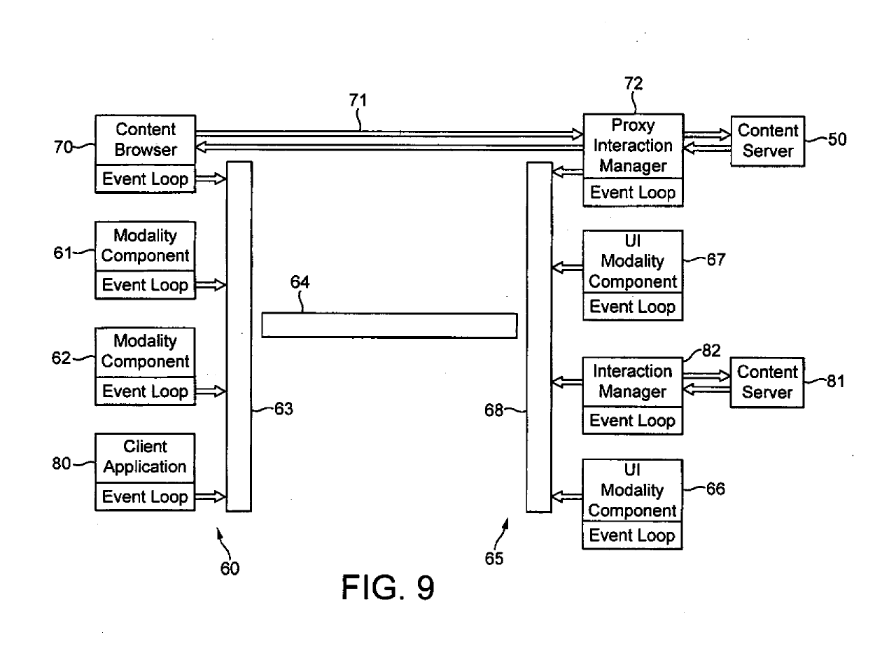

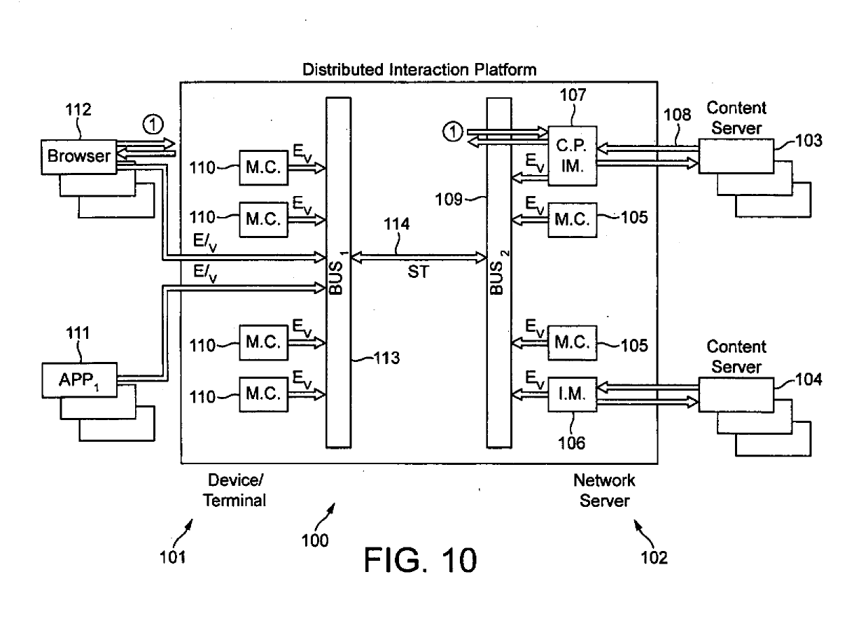

FIG. 9 shows a further arrangement of a user-interface system that is in accordance with the present invention. The arrangement shown in FIG. 9 is basically an overall combination of the systems described above with reference to FIGS. 7 and 8. Thus the terminal device 60 has, inter alia, user-interface components including one or more content browsers 70 and One or more client or terminal applications 80. Similarly, the interaction platform 65 on the communications network includes a content proxy 72, and an interaction management user-interface component 82, as described above with reference to FIGS. 7 and 8, etc

FIG. 10 shows schematically an exemplary further embodiment of a system 100 for providing multi-modal user interfaces for user devices and terminals of a communications system that is in accordance with the present invention. The system can be implemented, for example, on a known, mobile communications system, or on any other suitable form of communications system infrastructure.

The system shown in FIG. 10 includes a terminal device 101 of the communications system (as will be appreciated by those skilled in the art, the communications system as a whole will include a large number of terminal devices 101; FIG. 1 simply shows a single terminal device 101 for clarity), a network server 102 on the communications network that acts as an “interaction platform” which provides user interface services and functions, and one or more content and application resource servers 103, 104 which are accessible via the communications system and provide content and resources to and for the terminal device 101, and interaction platform 102 etc.

As will be appreciated by those skilled in the art, the communications system in which the system shown in FIG. 10 is implemented will also include other components and parts, etc., such as one or more base stations, switching and management infrastructure, other terminal devices, other resource platforms, etc. These components have been omitted from FIG. 10 for clarity.

The terminal device 101 may, for example, be a communications device, such as a mobile phone or radio, a PDA (Personal Digital Assistant), or it may be another component, such as a personal computer, or digital or interactive television set-top box, etc.

The network server interaction platform 102 provides in particular a number of functions and services that in effect allow multi-modal and in particular speech-enabled user interface functions and services to be provided to the terminal device 101 of the system, and includes a number of user-interface components for this purpose.

The content and application resource servers 103, 104 provide, for example, the resources such as user-interface controls required by applications of the terminal device 101, and also any resources and content necessary for the provision of the user interface on the terminal device 101, such as content and resources that may be needed by the network server interaction platform 102 to provide the necessary user interface functions and services to the terminal device 101. These content and application resource servers 103, 104 can be implemented in any suitable fashion, such as, for example, as a content server platform or platforms that are on or accessible via the communications system infrastructure.

As will be appreciated by those skilled in the art, on operation of the system of the present embodiment, there will need to be communication of content, signalling, and other data between the various components of the system, such as the terminal device 101, the network server interaction platform 102, and the content and application servers with application resources; user-interface controls, etc., 103, 104. For example, in the case of a speech enabled application's operation, there may need to be communication both of a user's captured spoken commands between the terminal device 101 and the network server interaction platform 102, and of user interface signalling and commands and data and application content between the terminal device 101 and the network interaction platform 102.

These communications are transmitted using the existing communications channels of the communications system infrastructure in which the system 100 is implemented, and are provided in the present embodiment by tunnelling the relevant signalling communications and content, etc, into the existing signalling protocols of the communications network in which the system is implemented. In the present embodiment, this is achieved by wrapping the relevant signalling and content into a standard telecommunication signalling protocol (e.g. messages or data units) that is used by the communications system infrastructure. However, other arrangements, such as the use of dedicated communications channels, (and, e.g. the use of publish-subscribe signalling channels where the communications network supports that), would, of course, be possible.

As shown in FIG. 10, the network server interaction platform 102 includes a number of user-interface components 105 that implement in particular distributed speech recognition and interaction functions based on speech that is received from the terminal device 101, and also provide appropriate audio prompts and interaction responses for implementation by the terminal device 101 in response, for example, to a user's spoken commands. It can support both browsing and client-based, terminal, applications and can run multiple applications simultaneously. It includes functionality whereby it can co-ordinate which application of a terminal device is currently active (in the foreground) and activate the relevant resources in response thereto.

The network server 102 also includes an interaction management user-interface component 106. This interaction management component 106 enables user interface functions and services for applications on the terminal device 101. To do this, it manages interaction events relating to terminal applications, acquires application content files with user-interface controls and resources such as interaction grammars, prompts etc., from the content servers 104 when required, publishes interaction events (e.g. as XML messages), e.g. to an automatic speech recognition user-interface component so that that component can activate the required voice resources, and may also, e.g., track a measure of user expertise for application usage.

The interaction management user-interface component 106 is also configured to receive from the client side (terminal device) information, e.g. in the form of an interaction event, indicating which application or applications of the terminal device 101 are currently active or in the foreground, and to act accordingly, e.g. store or retrieve status of other application sessions that may be running as appropriate. The arrangement is such that, in particular, the activation of new applications on the terminal device 101 by the user is detected and used to switch and/or activate, if necessary, the necessary resources on or via the interaction platform 102. This allows the user to switch to and from several applications that may be running concurrently whilst still receiving multi-modal user interface functions. This is achieved by the activation of applications generating interaction events, which are then subscribed by the interaction platform user-interface components in order to activate the required resources, etc.

The interaction platform 102 also includes a user-interface component in the form of a content proxy 107. This is used for browsing applications. It can receive requests for browsing content from the terminal device 101, and in response to them, retrieves the relevant content from the appropriate content server 103 via a browsing content channel 108.

The content, proxy user-interface component 107 also recognises instructions or events for user interface functions, such as a requirement for speech resources, that are provided as part of the retrieved browsing content, and publishes interaction events accordingly for other user-interface components of the interaction platform 102 to handle. This is facilitated by using XML tags describing user-interface controls in the browsing mark-up (other arrangements would, of course, be possible) that the content proxy 107 can then recognise and process. For example, tags can be added to indicate the play of speech output, such as particular words to be spoken, or audio files to be played back to the user, in the browsing or application content, that can then be identified by the interaction content proxy 107, which can then publish appropriate interaction events which can be subscribed to by other user-interface components to activate the relevant platform resources (user-interface components) as required. Thus the content proxy 107 extracts and interprets XML tags that are included in the browsing Content to activate platform resources as required.

The various components of the network server interaction platform 102 communicate with each other via a publish-subscribe bus 109, as discussed above.

As shown in FIG. 10, the terminal device 101 also includes a number of user-interface components 110 and includes or supports one or more applications that may use or be provided with multi-modal user interface functions, such as games, a phonebook, a calendar, etc. In the arrangement shown in FIG. 10, it is assumed that the terminal device 101 provides and supports one or more terminal or device applications 111, and one or more mobile browsers 112 (which are responsible for terminal device content browsing and, e.g., send a user's requests to the content proxy user-interface component 107 of the interaction platform 102). Other applications and arrangements would, of course, be possible.

The various components of the terminal device 101 again communicate with each other via a publish-subscribe bus 113.

In order to facilitate the provision of user interface functions and services to the terminal device 101, the interaction platform 102 and the terminal device 101 maintain a set of distributed sessions (i.e. sets of current data (parameters, etc.)) relating to applications of the terminal device 101 that is synchronised over a distributed publish-subscribe bus 114 linking the terminal device 101 and platform 102 when necessary. In particular, a session that is used in common for all concurrently running applications of the terminal device 101 (which maintains, for example, data that is applicable to or is to be used for all the applications in common (such as data relating, e.g., to the communications conditions between the interaction platform 102 and the terminal device 101)) is maintained, together with a separate session for each individual application of the terminal device 101 (e.g. that is currently activated).

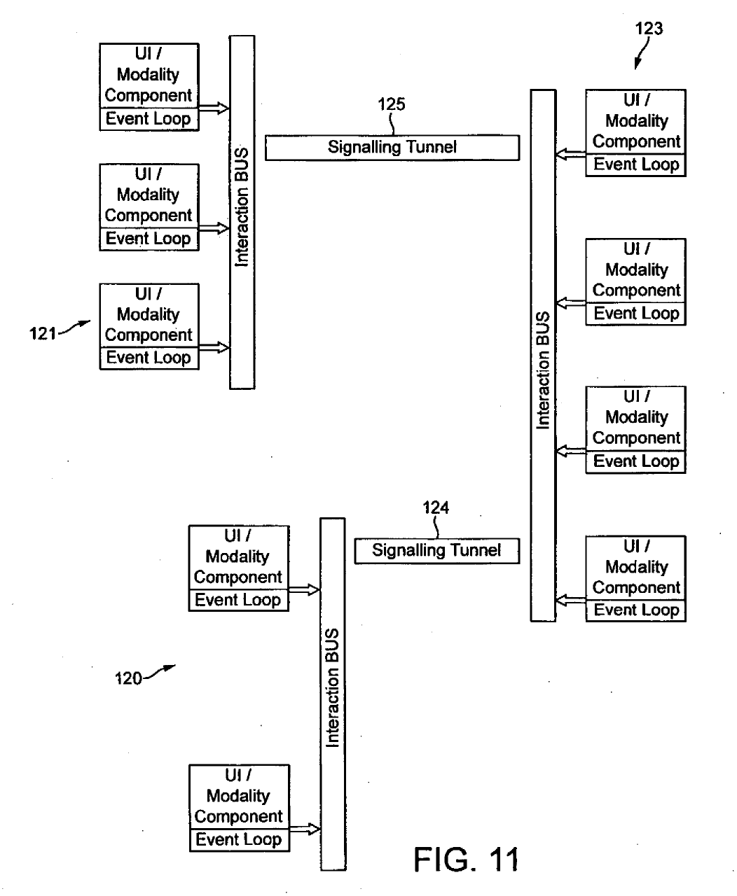

FIG. 11 shows a further preferred embodiment of the present invention. The arrangement shown in FIG. 11 is similar to that shown in FIG. 10, but in this case there are two devices 120, 121 on the client side of the system, both of which can access and communicate with the server side 123 via respective communications channels (signalling tunnel arrangements) 124, 125.

Each device 120, 121 has its own user interface components (which may be the same on each device) and publish-subscribe bus, etc., but as shown the two devices both use (share) the server-side interaction platform 123 and resources, etc. This embodiment accordingly illustrates how the present invention may be applied to and used with and for plural electronic (client) devices.

In such a multiple device arrangement, the two devices 120, 121 could, e.g., each be mobile phones belonging to different users, or they could, e.g., be two different devices of the same user, such as a mobile phone and an interactive-television. In the latter case, the user could, e.g., be interacting by using both devices simultaneously (such as talking via the phone and visually via the TV, which would then provide, in effect, a multi-device user interface).

Other arrangements, such as having more than two client-side devices, would, of course, be possible.

It should be noted here that although in the above embodiments of the present invention the various user-interface components on the network (server) side have primarily been described as being arranged on a platform on the network, this is not essential, and other arrangements, such as more distributed arrangements of user-interface components, or the provision of plural “platforms” (each having the same or different user-interface components), etc., could be used if desired.

As can be seen from the above, the present invention, in its preferred embodiments at least, provides an architecture for in particular the provision of multi-modal user interfaces for electronic devices in a mobile telecommunications environment, that is, for example, particularly advantageous for telecommunications grade deployments.

Furthermore, the architecture can be scalable and reliable and provide sufficiently high quality of service. The architecture can be used in existing and new networks and integrated with other systems, and can be used with different network types, including hybrid networks. It supports multi-modal user interfaces for both browsing and other device-based applications, and facilitates the addition of further modes of user interaction as and when desired.

The present invention, in its preferred embodiments at least, also facilitates the sharing of user-interface (modality) components among several applications, e.g., concurrently, and a distributed arrangement of user-interface components and resources for those components (e.g. across the client side, server side, or both).

This is achieved, in the preferred embodiments of the present invention at least, by providing distributed interaction queue arrangements, and/or by providing aspects of the user-interface functionality in a distributed manner, such as on a platform that is autonomous and that can operate independently of, and is independent of, the services and/or applications, etc., that are using it.

In particular, in the preferred embodiments of the invention, the user interface comprises a plurality of user-interface components, each of which has its own associated event queue (more than one user-interface component can share an event queue). Event queues and their related user interface components can be connected to form a single, logical distributed event queue, preferably via a publish-subscribe bus. Such interaction bus arrangements can be split and joined, using, e.g. signalling tunnels.

1. (canceled)

2. The method of claim 6, wherein the user-interface system further comprises the plurality of user interface components and wherein each of the user-interface component components has its own, separate, interaction event queue.

3. (canceled)

4. The method of claim 6, further comprising the step of initiating an action that is possible at one of the user-interface components associated with one of the event queues to which an event is first posted in response to a posting of the event without waiting for the event to be posted to any other of the event queues.

5. (canceled)

6. A method of operating a user-interface system for an electronic device, in which the user-interface system comprises at least one of a plurality of user-interface components and a plurality of user interface interaction event queues, the method comprising the step of:
transmitting messages between at least two of the user-interface components and the user-interface interaction event queues of the user-interface system using a publish-subscribe bus arrangement.

7. The method of claim 6, wherein:
the electronic device further comprises at least one user-interface component, and wherein at least one more user-interface component on or accessible via a communications network to which the electronic device connects; and
the method further comprises:
maintaining at least one interaction event queues on the electronic device and maintaining at least one interaction event queue on or accessible via the communications network.

8. The method of claim 7, further comprising transmitting signalling between at least two of the user-interface components and the user-interface interaction event queues on the electronic device and the user-interface components and the interaction event queues on or accessible via the communications network by tunnelling the signalling over at least one communications channel of the

9. (canceled)

10. The method of claim 6 further comprising:
the electronic device transmitting a request for content from a content server;
a component for providing user-interface functions receiving the request and in response thereto fetching the requested content from the content server; and
the component further for providing user-interface functions identifying and processing at least one user interface control included in the fetched content and providing the fetched content to the electronic device.

11-12. (canceled)

13. The method of claim 6 further comprising:
providing at least one of data and/or instructions for at least one user-interface controls for an application not in a code for the application or with the application itself, wherein the at least one of data and instructions comprises a separate document or file activated and executed approximately concurrently with the application.

14-18. (canceled)

19. The method of claim 6, further comprising the step of maintaining a session for an application that is active on the electronic device.

20-21. (canceled)

22. The method of claim 6 further comprising the steps of:
identifying an application of the electronic device that is currently active; and
providing that identification to at least one of the user-interface components.

23-24. (canceled)

25. The method of claim 6 wherein the electronic device further comprises a communications device.

26. (canceled)

27. The system of claim 33, further comprising the plurality of user-interface components, wherein each user-interface component has its own, separate, interaction event queue.

28. The system of claim 33, further comprising:
at least one user-interface component having at least one associated interaction event queue on the electronic device, and at least one user-interface component having at least one associated interaction event queue on or accessible via a communications network to which the electronic device is connected.

29-30. (canceled)

31. The system of claim 33, further comprising the plurality of user-interface components, wherein at least one of the user-interface components comprises means for initiating an action that is possible at the user-interface component in response to the posting of an event at an event queue associated with the user-interface component without waiting for the event to be posted to any other event queues.

32. (canceled)

33. A system for providing a user-interface for an electronic device, the system comprising:
at least one of a plurality of user-interface components and plurality of user interface interaction event queues; and
a publish-subscribe bus arrangement for conveying communications between at least two of the user-interface components and the user-interface interaction event queues.

34. The system of claim 33, further comprising the publish-subscribe bus arrangement linking at least two of the user-interface components and the interaction event queues on a communications network infrastructure to which the electronic device is connected, and a second publish-subscribe bus arrangement linking at least two of the user-interface components and the interaction event queues on the electronic device, wherein the publish-subscribe bus arrangements are linked, providing a publish-subscribe signalling arrangement between the at least one of the user-interface components and the interaction event queues on the network infrastructure and at least one of the user-interface components and the interaction event queues on the electronic device.

35. The system of claim 33, further comprising means for transmitting signalling between at least one of the user-interface components and the interaction event queues on the electronic device and at least one of a user-interface component and an interaction event queue on or accessible via a communications network by tunnelling the signalling over at least one communications channel of the communications network.

37. The system of claim 33, further comprising a user-interface component on or accessible via a communications network comprising a content proxy for browsing applications of the electronic device; and wherein the content proxy comprises means for fetching content and means for identifying and processing at least one of data and instructions relating to a user interface controls in the content that it fetches.

38-40. (canceled)

41. The system of claim 33, further comprising:
means for storing separately to a program code for an application that is to be executed on or for the electronic device, a set of at least one of data and instructions relating to at least one user-interface control to be executed during execution of the application to provide at least one of user-interface functions and operations relating to the application.

42-50. (canceled)

51. The system of claim 33, further comprising means for identifying an application of the electronic device that is currently active and means for providing the identification to at least one of the user-interface components.

52-53. (canceled)

54. The system of claim 33, wherein the electronic device further comprises a communications device.

55. (canceled)

56. A computer program element comprising computer software code portions for performing the method of claim 6 when the program element is run on a data processor.

57-60. (canceled)
